(19) United States
(12) Patent Application Publication
(10) Pub. No.: US 2006/0263658 A1
(43) Pub. Date: Nov. 23, 2006

(54) Fuel cell system

(76) Inventors: Takuo Yanagi, Toyota-shi (JP); Norio Yamagishi, Nishikamo-gun (JP); Nobuo Fujita, Toyota-shi (JP)

Correspondence Address: KENYON & KENYON LLP, 1500 K STREET N.W., SUITE 700, WASHINGTON, DC, 20005, US

(21) Appl. No.: 10/569,418

(22) PCT Filed: Aug. 18, 2004
(86) PCT No.: PCT/IB04/02694

§ 371 Date: Feb. 23, 2006

(30) Foreign Application Priority Data
Sep. 9, 2003 (JP) 2003-317287
Mar. 31, 2004 (JP) 2004-107828

(51) Int. Cl. H01M 8/04

(52) U.S. Cl. 429/22; 429/25

(57) ABSTRACT

A fuel cell system which reduces a quantity of hydrogen in hydrogen off-gas discharged from a fuel cell, and then discharges the hydrogen off-gas to atmosphere, includes an adjusting valve that suppresses a pulsed change in a flow quantity of hydrogen off-gas, which is intermittently discharged from the fuel cell to an exhaust passage and therefore flows in the exhaust passage in a pulse manner, such that the flow quantity becomes constant (stable).

This is a 371 national phase application of PCT/IB2004/002694 filed 18 Aug. 2004, claiming priority to Japanese Patent Application No. JP 2003-317287 filed 9 Sep. 2003, and No. JP 2004-107828 filed 31 Mar. 2004, the contents of which are incorporated herein by reference.

### BACKGROUND OF THE INVENTION

1. Field of the Invention

The invention relates to a fuel cell system and an electric vehicle using the fuel cell system. More particularly, the invention relates to improvement of a fuel cell system in which remaining hydrogen is caused to flow back.

2. Description of the Related Art

A fuel cell receives supply of hydrogen gas and oxygen gas (oxidizing gas) to generate electric power. Gas containing remaining hydrogen that has not been consumed in the fuel cell is discharged to the outside of the fuel cell as hydrogen off-gas. Also, gas containing remaining oxygen that has not been consumed in the fuel cell is discharged to the outside of the fuel cell as oxygen off-gas. Since hydrogen gas remains in the hydrogen off-gas, fuel efficiency can be improved by causing the hydrogen off-gas to flow back to a hydrogen gas supply side of the fuel cell.

In the case where such hydrogen off-gas is circulated in the fuel cell, nitrogen (N₂) that has permeated to an anode side from a cathode side of the fuel cell is stored, which inhibits electrochemical reaction, and decreases output of a unit cell of the fuel cell. Also, humidifying water in the hydrogen gas and water generated due to electrochemical reaction remain in the fuel cell, which inhibits electrochemical reaction, and decreases output of a unit cell of the fuel cell. Accordingly, a discharge valve is provided in a hydrogen off-gas circulation system, and the hydrogen off-gas is intermittently discharged to the outside of the fuel cell via the discharge valve via the discharge valve, whereby a decrease in output of the fuel cell is prevented.

When the hydrogen off-gas is discharged to the outside of the fuel cell system, the hydrogen off-gas and the oxygen off-gas are mixed in a chamber such that a hydrogen concentration is reduced as disclosed in Japanese Patent Laid-Open Publication No. 2003-132915 (JP-A-No. 2003-132915), or hydrogen is subjected to combustion treatment using a catalyst as disclosed in Japanese Patent Laid-Open Publication No. 2002-289237 (JP-A-No. 2002-289237). In a fuel cell system disclosed in Japanese Patent Laid-Open Publication No. 2002-289237, the hydrogen off-gas is temporarily stored in a chamber in a discharge passage, hydrogen off-gas is gradually discharged from the chamber to a confluence portion where the hydrogen off-gas is mixed with the oxygen off-gas and is diluted by the oxygen off-gas, and the hydrogen is subjected to combustion treatment by a combustor including a catalyst.

Although the chamber for diluting the hydrogen off-gas disclosed in the Japanese Patent Laid-Open Publication No. 2003-132915 and the combustor for performing combustion treatment for the hydrogen disclosed in the Japanese Patent Laid-Open Publication No. 2002-289237 are effective for reducing the hydrogen concentration when the hydrogen off-gas is discharged to the atmosphere, a flow quantity of the hydrogen off-gas intermittently flowing into the chamber or the combustor varies depending on an operating state (load) of the fuel cell. Therefore, the size of the chamber or the combustor needs to be large in order to deal with the maximum quantity (peak quantity) of the hydrogen off-gas. Particularly, in the case of an in-vehicle fuel cell system, since a space where the fuel cell system is mounted is limited, size of such a hydrogen off-gas discharge mechanism needs to be reduced. Also, since platinum which is generally expensive is used in the catalyst in the combustor, the cost of the combustor (catalyst) is high if the size of the combustor (catalyst) is large.

Document US 2003/077488 A1 discloses a discharged fuel diluter and a discharged fuel dilution-type fuel cell system, wherein the fuel diluter includes a retention region with a predetermined volume, into which a fuel discharged from a fuel cell is retained at the time of purging, and a dilution region with a predetermined volume, through which air discharged from the fuel cell flows and at which the air is mixed with the fuel from the retention region to dilute the fuel.

Further, document US 2001/018142 A1 discloses a fuel cell system including a fuel cell for generating electric energy by chemical reaction between hydrogen and oxygen. The system includes an inflow passage valve provided in a hydrogen inflow passage through which hydrogen is supplied to the fuel cell stack. Hydrogen is supplied to the stack intermittently in accordance with the consumed hydrogen by controlling opening and closing of the inflow passage valve and the hydrogen discharge valve.

Still further, document EP 0356 906 A1 discloses a fuel cell stack assembly for hydrogen fuel reforming in a fog cooled fuel cell power plant assembly, wherein the power section of a phosphoric fuel cell power plant is cooled by injection of water droplets or fog into the anode gas stream. The, anode exhaust with the water vapor therein is then split with a portion thereof being directed to the burner in the catalytic reformer to be consumed by the reformer burner. The remainder of the anode exhaust is routed to the reformer inlet where it provides the water necessary for the reforming reaction. The fog is produced by condensation of water out of the exhaust from a turbocompressor which compresses the air supply for the cathode side of the power section.

Furthermore, document US 2003/129472 A1 discloses a check valve and a fuel cell system using this check valve. The check valve is disposed in a hydrogen offgas circulation path which is connected to a fuel cell so as to flow the hydrogen offgas only in one direction. Inside a valve housing, a first compression chamber and a second compression chamber are provided such that a bulkhead is disposed therebetween. In the bulkhead, a first communication hole and a second communication hole are formed so as to communicate between the first compression chamber and the second compression chamber. In a first lead valve, an opening end is disposed upward and a fixed end is disposed downward. In a second lead valve, an opening end is disposed downward and a fixed end is disposed upward.

Document WO 2004/51780 A discloses a fuel cell system including a fuel cell, a supply system, a recirculation system, a purge valve and a controller for adjusting a valve opening of the purge valve so that a nitrogen concentration of the fuel gas in the recirculation system is kept constant.

Document US 2002/094469 A1 discloses an onboard fuel cell system and method for discharging hydrogen-off gas, wherein consumed hydrogen-off gas is discharged from a fuel cell via a hydrogen-off gas exhaust flow passage and consumed oxygen-off gas is discharged from the fuel cell via an oxygen-off gas exhaust flow passage. The oxygen-off gas flowing through the oxygen-off gas exhaust flow passage and the hydrogen-off gas flowing through the hydrogen-off gas exhaust flow passage are mixed and diluted in a mixing portion. The gases mixed in the mixing portion flow into a combustor via a gas-liquid separator. The combustor, which includes a platinum catalyst, causes hydrogen contained in the mixed gases to react with oxygen by combustion and further reduces the concentration of hydrogen contained in the mixed gases. The mixed gases whose concentration of hydrogen has been reduced by the combustor is discharged to the atmosphere consumed hydrogen-off gas as well as consumed oxygen-off gas which are discharged from the fuel cell are mixed and diluted in a mixing portion. A buffer is provided downstream of a shut valve and before the mixing portion. This buffer has different inlet and outlet diameters, wherein the outlet diameter is smaller than the inlet diameter.

### SUMMARY OF THE INVENTION

It is an object of the invention to provide a fuel cell system in which size of a hydrogen off-gas discharge mechanism is made small by making a flow quantity of hydrogen off-gas or a concentration of hydrogen in the hydrogen off-gas constant.

A first aspect of the invention relates to a fuel cell system which reduces a concentration of hydrogen in hydrogen off-gas discharged from a fuel cell, and then discharges the hydrogen off-gas to atmosphere. The fuel cell system includes an adjusting valve (a flow quantity control valve, a pressure adjusting valve, an opening/closing valve, or the like) which adjusts a flow quantity of the hydrogen off-gas (or a concentration of hydrogen in the hydrogen off-gas) to a constant flow quantity (or a constant concentration), the adjusting valve being provided in an exhaust passage through which the hydrogen off-gas discharged from the fuel cell continuously or intermittently is guided to an outside of the fuel cell system.

With this configuration, a pulsed change in the flow quantity of the hydrogen off-gas (or the concentration of hydrogen in the hydrogen off-gas) in the exhaust passage can be reduced, the flow quantity of the hydrogen off-gas can be made uniform (constant), and accordingly the effect of the catalyst can be made stable even when the operating state of the fuel cell is changed. Also, the used quantity of the expensive catalyst can be reduced. Further, the concentration of the hydrogen in the exhaust gas can be maintained at a low value easily in the case where the hydrogen off-gas is diluted and is discharged to the atmosphere without being subjected to combustion treatment using the catalyst.

The adjusting valve may be a mechanical adjusting valve or an electromagnetic valve whose opening/closing amount is controlled based on an operating state of the fuel cell.

The fuel cell system may further include gas state detecting means for detecting a state quantity of the hydrogen off-gas in the exhaust passage (for example, the flow quantity of the hydrogen off-gas or the concentration of hydrogen in the hydrogen off-gas, or the flow quantity of the hydrogen off-gas or the concentration of hydrogen in the hydrogen off-gas that is estimated based on the operating state of the fuel cell), and the adjusting valve may be controlled based on the detected state quantity. With this configuration, since opening/closing of the adjusting valve is controlled based on the detected state quantity, the flow quantity can be made stable.

Also, the fuel cell system may further include a chamber which temporarily stores gas, the chamber being provided upstream of the adjusting valve in the exhaust passage. With this configuration, since the hydrogen off-gas that is intermittently discharged is temporarily stored, the pulsed change in the flow quantity of the hydrogen off-gas is suppressed and the flow quantity of the hydrogen off-gas is made constant.

The fuel cell system may further include a confluence portion in which a fluid containing oxygen (air off-gas, air, oxidizing gas, or the like) and the hydrogen off-gas are mixed, the confluence portion being provided downstream of the adjusting valve. In the embodiment described below, the combustor serves as the confluence portion. However, a pipe for the hydrogen off-gas and a pipe for the air off-gas are connected to one pipe.

Also, the confluence portion may include hydrogen reducing means (for example, a dilution device, and conversion means (a catalyst and a combustor)) for reducing a concentration of hydrogen in the hydrogen off-gas by mixing the hydrogen off-gas and the fluid. The phrase “reducing a concentration of hydrogen” signifies that “reducing a concentration of hydrogen in the gas discharged from the hydrogen reducing means” and “reducing a total quantity of hydrogen discharged from the hydrogen reducing means”.

The fuel cell may further include a fluid state sensor which detects a state quantity (the flow quantity and the concentration) of the fluid flowing into the hydrogen reducing means, and the adjusting valve may be an electromagnetic valve whose opening/closing amount is controlled based on an output of the fluid state sensor.

Also, the hydrogen reducing means may include conversion means for oxidizing the hydrogen (a catalyst and a combustor) using the fluid, and the fuel cell system may further include temperature detecting means for detecting a temperature of a portion of the conversion means where the hydrogen is oxidized, and an opening/closing amount of the adjusting valve may be controlled based on the temperature.

With the configuration, since a quantity of the hydrogen-off gas introduced to the conversion means and a quantity of the air off-gas introduced to the conversion means can be changed according to an output of the temperature detecting means, an activation temperature of the conversion means can be maintained, and accordingly the hydrogen can be efficiently oxidized.

Also, the quantity of the fluid supplied to the conversion means may be controlled by the adjusting valve. With the configuration, an air-fuel ratio between the hydrogen and the oxygen can be adjusted to an appropriate value.

Also, the state quantity of the hydrogen off-gas may be pressure, and the opening/closing amount of the adjusting valve may be adjusted according to the pressure. With the configuration, the opening/closing amount of the adjusting valve can be set to an appropriate value according to the pressure detected, for example, by a pressure sensor that detects the pressure of the hydrogen off-gas.

Also, the state quantity of the hydrogen off-gas may be obtained based on an opening/closing state of a hydrogen purge valve that discharges the hydrogen off-gas from the fuel cell to the exhaust passage. With this configuration, since the opening/closing of the adjusting valve is controlled based on information on the opening/closing of the hydrogen purge valve, it is not necessary to provide a specific sensor for detecting the state quantity of the hydrogen off-gas.

Also, the flow quantity of the hydrogen off-gas guided to the exhaust passage may be adjusted by adjusting an opening area of the adjusting valve.

The exhaust passage may include at least two exhaust passages through which the hydrogen off-gas is guided to an outside of the fuel cell system, and the adjusting valve may include opening/closing valves each of which is provided in each of the at least two exhaust passages.

Each of the opening/closing valves may be controlled according to a state of the hydrogen off-gas on an upstream side of each of the opening/closing valves.

A second aspect of the invention relates to a fuel cell system which dilutes hydrogen off-gas discharged from a fuel cell, and then discharges the hydrogen off-gas to atmosphere. The fuel cell system includes a first passage through which dilution gas that can be used for diluting the hydrogen off-gas flows; a second passage through which the hydrogen off-gas is guided from the fuel cell; a confluence portion to which the first passage and the second passage are connected; and pressure adjusting means for adjusting pressure of the hydrogen off-gas and pressure of the dilution gas in the confluence portion, the pressure adjusting means being provided in at least one of the first passage and the second passage.

With this configuration, since a difference between the pressure of the air off-gas and the pressure of the hydrogen off-gas at the confluence portion is adjusted, a quantity of the hydrogen off-gas discharged to the confluence portion is made stable.

The pressure adjusting means may be provided in the second passage.

The pressure adjusting means may include an air compressor provided in an oxidizing gas supply passage on a cathode side of the fuel cell, and an adjusting passage that connects at least one of an intake side and a discharge side of the air compressor and the second passage.

The pressure adjusting means may include an opening/closing valve whose opening/closing amount can be adjusted according to the pressure in the confluence portion, the opening/closing valve being provided in the adjusting passage.

The adjusting passage may include a first adjusting passage that connects a supply passage on the intake side of the air compressor and the second passage, and a second adjusting passage that connects a supply passage on the discharge side of the air compressor and the second passage. The fuel cell system may further include pressure control means for making the pressure of the hydrogen off-gas lower than the pressure of the dilution gas in the confluence portion by forming negative pressure in the second passage through the first adjusting passage using the air compressor, and making the pressure of the hydrogen off-gas in the second passage higher than the pressure of the dilution gas in the confluence portion through the second adjusting passage using the air compressor.

A third aspect of the invention relates to a fuel cell system which dilutes hydrogen off-gas discharged from a fuel cell, and then discharges the hydrogen off-gas to atmosphere. The fuel cell system includes a first passage through which dilution gas that can be used for diluting the hydrogen off-gas flows; a second passage through which the hydrogen off-gas is guided from the fuel cell; a confluence portion to which the first passage and the second passage are connected; and a pressure adjusting device which adjusts pressure of the hydrogen off-gas and pressure of the dilution gas in the confluence portion, the pressure adjusting device being provided in at least one of the first passage and the second passage.

With this configuration, since a difference between the pressure of the air off-gas and the pressure of the hydrogen off-gas at the confluence portion is adjusted, a quantity of the hydrogen off-gas discharged to the confluence portion is made stable.

According to the aforementioned first to third aspects of the invention, since it is possible to suppress the pulsed change (fluctuation) in the flow quantity of the hydrogen off-gas or the concentration of hydrogen in the hydrogen off-gas that is discharged from the fuel cell intermittently (or continuously) such that the flow quantity or the concentration of hydrogen is made uniform, it is possible to make the effect of the catalyst stable and to reduce the used quantity of the catalyst. Thus, it is possible to perform the combustion treatment for the hydrogen off-gas using a small combustor.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein:

FIG. 1A is a diagram explaining a first embodiment, and FIG. 1B and FIG. 1C are graphs each explaining the first embodiment;

FIG. 2 is a diagram explaining a second embodiment;

FIG. 3 is a diagram explaining a third embodiment;

FIG. 4 is a diagram explaining a fourth embodiment;

FIG. 5 is a diagram explaining a fifth embodiment;

FIG. 6A is a diagram explaining a sixth embodiment, and FIG. 6B is a graph explaining the sixth embodiment;

FIG. 7A is a diagram explaining a seventh embodiment, and FIG. 7B to FIG. 7D are graphs each explaining the seventh embodiment;

FIG. 8 is a diagram explaining an eighth embodiment;

FIG. 9 is a diagram explaining a ninth embodiment;

FIG. 10A is a diagram explaining a tenth embodiment, and FIG. 10B and FIG. 10C are graphs each explaining the tenth embodiment;

FIG. 11A is a diagram explaining a comparative example, and FIG. 11B and FIG. 11C are graphs each explaining the comparative example;

FIG. 12 is a diagram explaining an eleventh embodiment;

FIG. 13A to FIG. 13C are graphs each explaining a control operation in the eleventh embodiment;

FIG. 14A to FIG. 14C are graphs each explaining another control operation in the eleventh embodiment;

FIG. 15 is a diagram explaining a twelfth embodiment; and

FIG. 16A to FIG. 16E are graphs each explaining a control operation in the twelfth embodiment.

### DETAILED DESCRIPTION OF THE PREFERRED EMBODIMENTS

Hereinafter, an embodiment of the invention will be described with reference to the accompanying drawings.

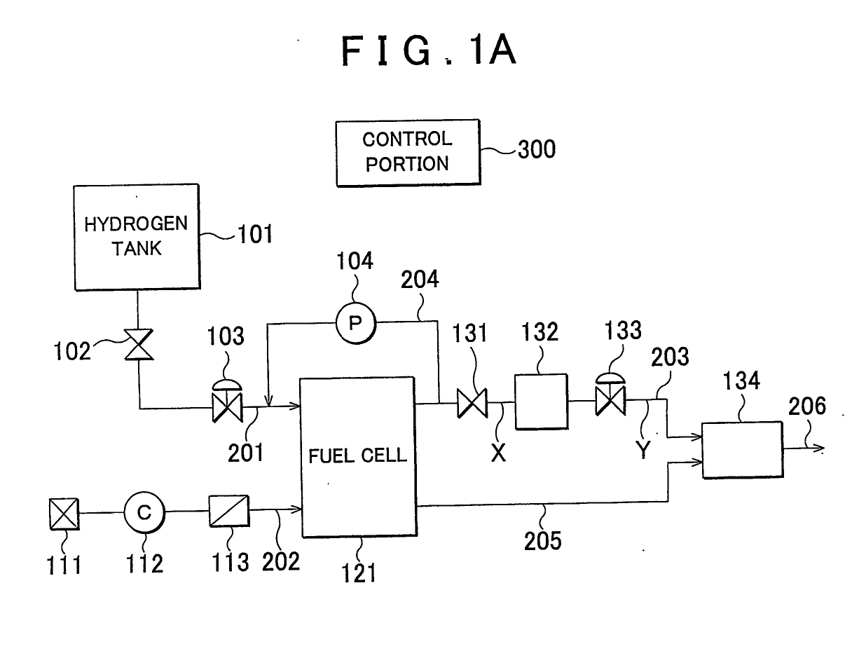

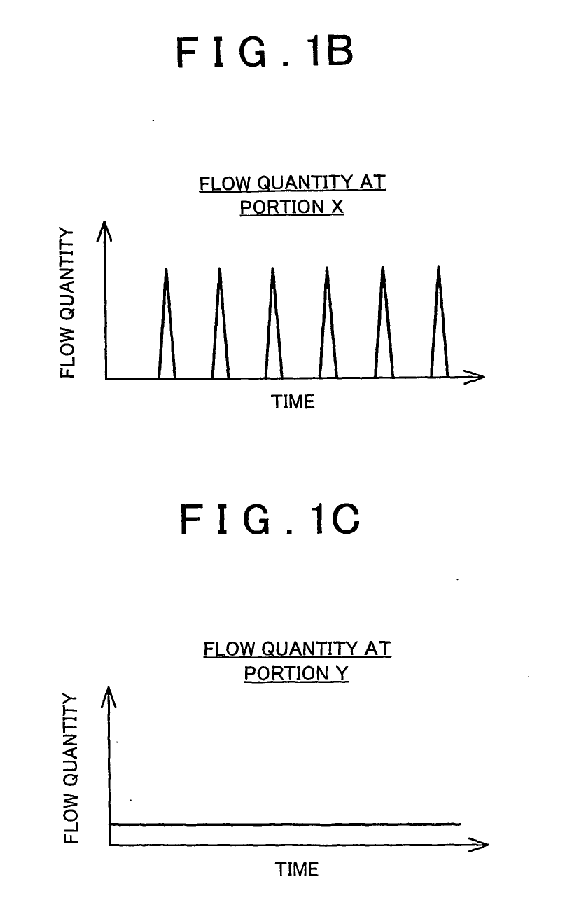

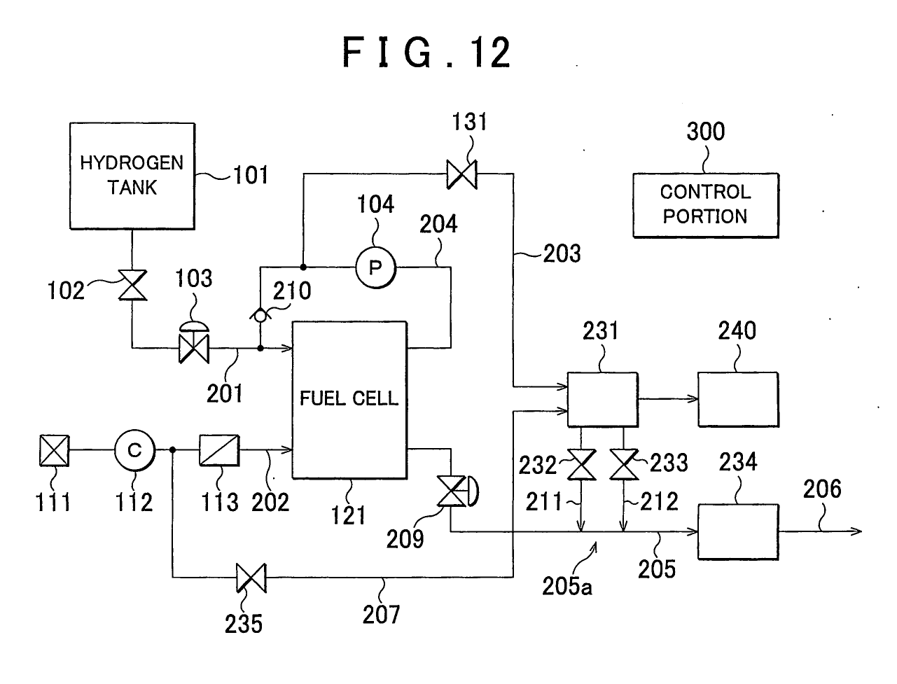

In the embodiment of the invention, hydrogen off-gas that is intermittently discharged from a fuel cell is stored in a chamber, and a quantity of the hydrogen off-gas flowing out of the chamber is adjusted to be constant by an adjusting valve. As the adjusting valve, a flow quantity control valve (a throttle valve or a flow quantity control valve with a pressure compensator), a pressure control valve (pressure reducing valve) or the like may be employed. The adjusting valve may be a mechanical valve or an electromagnetic valve. When a mechanical adjusting valve is used, there is an advantage that the flow quantity can be adjusted at relatively low cost. When the electromagnetic adjusting valve is used, there is an advantage that the flow quantity can be adjusted according to various conditions. Also, when a flow control valve that is unlikely to be influenced by a fluctuation of pressure, it is possible to omit a chamber which temporarily stores the hydrogen off-gas so as to reduce the fluctuation of pressure (for example, a chamber 132 in FIG. 1A described later and a chamber provided downstream of the adjusting valve described later (for example, a muffler 234 in FIG. 12)).

Since a constant quantity of hydrogen off-gas is supplied to the combustor, it is possible to avoid a situation where a large quantity of hydrogen off-gas is supplied to a catalyst in a combustor for a short time. Thus, it is possible to perform combustion treatment for hydrogen discharged from the fuel cell, using a catalyst whose quantity is small (small combustor). Also, the quantities of the hydrogen off-gas and oxygen off-gas that are supplied to the combustor are controlled such that efficiency of the catalyst becomes optimum.

### First Embodiment

FIG. 1A to FIG. 1C schematically show a first embodiment of the invention. FIG. 1A shows a high-pressure hydrogen tank 101 for storing hydrogen, an opening/closing valve (shutoff valve) 102 for interrupting supply of hydrogen gas from the high-pressure hydrogen tank 101, a pressure adjusting valve 103 for adjusting the pressure (flow quantity) of the hydrogen gas supplied to a fuel cell 121, and a pump 104 for causing exhaust gas (hydrogen off-gas) containing remaining hydrogen gas that has not been used to flow back to the fuel cell 121. FIG. 1A also shows an air filter 111 for removing dust in the air, a compressor 112 for delivering air, and a humidifier 113 for humidifying air. The fuel cell 121 is, for example, a polymer electrolyte fuel cell. The fuel cell receives supply of hydrogen gas and air (oxidizing gas) to generate electric power. FIG. 1A also shows an opening/closing valve 131 for discharging the hydrogen off-gas to the outside of the fuel cell 121, a chamber 132 having a capacity sufficient for temporarily storing the hydrogen off-gas, a mechanical flow quantity control valve (adjusting valve) 133 which allows the hydrogen off-gas stored in the chamber 132 to flow out such that the flow quantity is constant, and a combustor 134 which performs combustion treatment for hydrogen using a platinum catalyst. The hydrogen off-gas is supplied to the combustor 134 from the flow quantity control valve 133, and air off-gas is supplied to the combustor 134 from the fuel cell 121. The combustor 134 serves as a confluence portion where the hydrogen off-gas and the air off-gas are mixed. Moisture that is generated due to the combustion treatment in the combustor 134 is discharged to the outside of the fuel cell system (the atmosphere). In FIG. 1, a hydrogen gas supply passage 201 extends from the hydrogen tank 101 to the fuel cell 121. An air (oxidizing gas) supply passage 202 extends from the air cleaner 111 to the fuel cell 121. A hydrogen off-gas passage (exhaust passage) 203 is a passage through which the hydrogen off-gas is guided from the fuel cell 121 to the combustor 134. A hydrogen off-gas circulation passage 204 is a passage through which the hydrogen off-gas is guided from the fuel cell 121 to the hydrogen gas supply passage 201. An air off-gas passage 205 is a passage through which the air off-gas is guided from the fuel cell 121 to the combustor 134. Exhaust gas is discharged from the combustor 134 to the atmosphere through an outside exhaust passage 206. A control portion 300 controls the aforementioned opening/closing valve 102, the pressure adjusting valve 103, the circulation pump 104, the compressor 112, the opening/closing valve 131, and the like. The control portion 300 is configured using a computer system for control.

Next, operation of the fuel cell system performed by the control portion 300 will be described. The control portion 300 opens the opening/closing valve 102 of the hydrogen tank 101 according to an electric power generation command from a portion outside the control portion 300. Also, the control portion 300 sets the flow quantity of hydrogen gas supplied to the fuel cell 121 by adjusting the pressure adjusting valve 103 in order to generate a required quantity of load electric power. Also, the control portion 300 operates the compressor 112, humidifies air of a quantity corresponding to the quantity of hydrogen gas, and supplies the air to the fuel cell 121. When the hydrogen gas and air (oxidizing gas) are delivered to the fuel cell 121, electrochemical reaction occurs in each cell, and electromotive force is generated between the anode and the cathode (not shown) in the fuel cell 121. The electric power is supplied to a motor and a secondary battery of the vehicle.

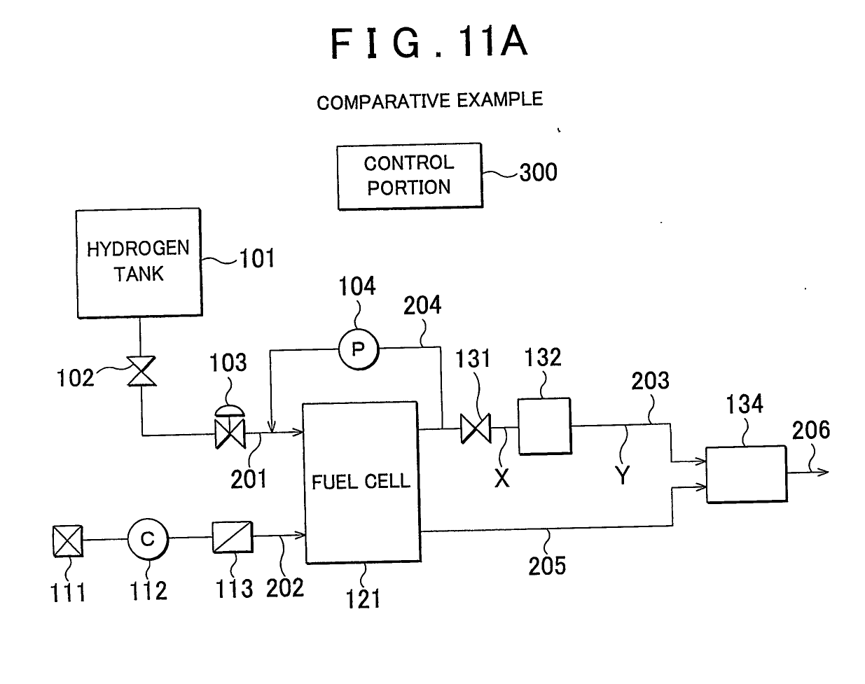

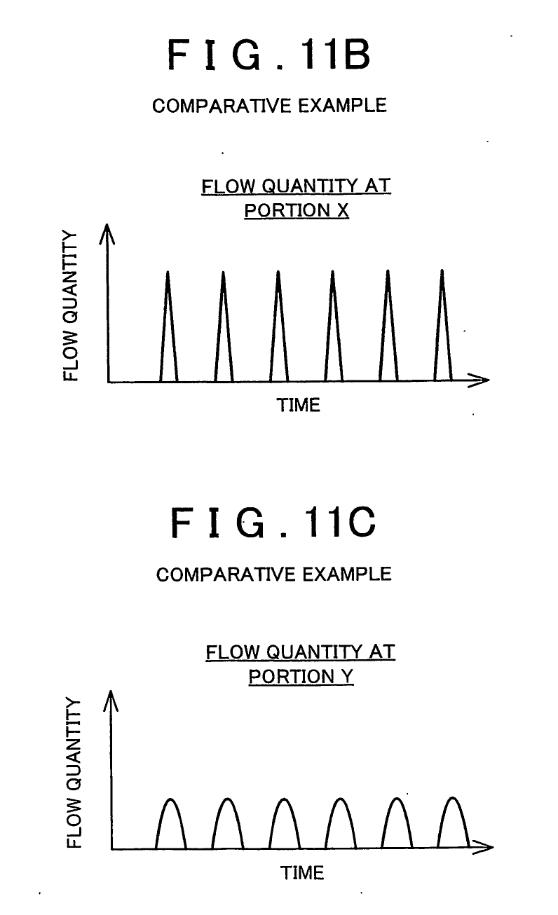

The control portion 300 periodically opens the opening/closing valve 131 for a short time during operation of the fuel cell 121, and discharges (purges) hydrogen off-gas. As shown in FIG. 1B, the flow quantity of the purged hydrogen off-gas changes in a pulse manner with a peak value being high due to a change in the pressure at a portion X in FIG. 1A. The control portion 300 sets an opening cycle of the opening/closing valve 131 according to a state of the load. When the load is large, the opening cycle of the opening/closing valve 131 is short. When the load is small, the opening cycle of the opening/closing valve 131 is long. The hydrogen off-gas is stored in the chamber 132, and a change in the flow quantity of the hydrogen off-gas is reduced due to a capacity of the chamber 132, and the hydrogen off-gas flows in the pulse manner (refer to FIG. 11C described later).

Further, as shown in FIG. 11C, the pulsed change in the quantity of the hydrogen off-gas flowing out of the chamber 132 is suppressed by the mechanical flow quantity control valve 133. As a result, the flow quantity of the hydrogen off-gas flowing out of the chamber 132 at a portion Y is adjusted to be stable (uniform). Thus, the substantially constant flow quantity of the hydrogen off-gas is supplied to the combustor 134 together with the air off-gas, and is subjected to the combustion treatment using a platinum catalyst.

As shown in FIG. 1C, since the flow quantity of the hydrogen off-gas is constant, the effect of the platinum catalyst in the combustor 134 becomes stable in a subsequent stage in which the hydrogen off-gas is subjected to the combustion treatment. Also, a quantity of the catalyst is small as compared with the case where the peak flow quantity of the hydrogen-off gas is subjected to the combustion treatment in the combustor 134 without using the chamber 132 and the flow quantity adjusting valve 133 (refer to FIG. 11B), or the case where the peak flow quantity of the hydrogen-off gas is subjected to the combustion treatment in the combustor 134 without using the flow quantity adjusting valve 133 (refer to FIG. 11C described below).

Instead of the oxygen off-gas supplied to the combustor 134, the air outside the fuel cell system may be used, not only in this embodiment but also in the embodiments described later.

The opening/closing amount of the flow quantity adjusting valve 133 may be adjusted through the control portion 300 according to the opening state of the opening/closing valve 131 which is a hydrogen purge valve. For example, in both the case where the opening/closing valve 131 is opened for a predetermined opening time period, and a cycle from when the opening/closing valve 131 is closed until when the opening/closing valve 131 is opened next time is changed, and the case where the cycle is constant, and the opening time period of the opening/closing valve 131 per unit cycle is changed, the flow quantity adjusting valve 133 is opened according to the proportion of the opening time period of the opening/closing valve 131 per unit time, that is, the flow quantity adjusting valve 133 is opened to a larger degree as the proportion of the opening time period of the opening/closing valve 131 is larger. Thus, the pressure of the hydrogen off-gas in the chamber 132 can be made substantially constant without using a particular sensor. Accordingly, the pulsed flow of the hydrogen off-gas supplied to the combustor 134 can be suppressed, and at the same time, the discharge quantity of the hydrogen off-gas can be adjusted. This control operation can be performed since the control portion 300, which performs the control of the opening state of the opening/closing valve 131, that is, performs the control to decide whether to open or close the opening/closing valve 131, detects the opening state of the opening/closing valve 131, and generates a signal for controlling the opening/closing amount of the flow quantity adjusting valve 133.

FIG. 11A shows a fuel cell system in a comparative example for clarifying the effect of the first embodiment. In FIG. 11A, the same portions as in FIG. 1 are denoted by the same reference numerals, and description thereof will be omitted.

As shown in FIG. 11A, the flow quantity control valve (adjusting valve) 133 for suppressing the pulsed change in the flow quantity is not provided between the chamber 132 and the combustor 134. As a result, the pulsed change in the flow quantity of the hydrogen off-gas is not reduced much at the portion X, and the flow quantity of the hydrogen off-gas supplied to the combustor 134 greatly changes in the pulse manner at the portion Y In order to perform the combustion treatment for the hydrogen off-gas in the combustor 134, it is necessary to provide a catalyst having a treatment capacity sufficient for dealing with the peak quantity of the hydrogen off-gas. Therefore, a larger quantity of expensive platinum catalyst is necessary, and accordingly size of the combustor 134 needs to be larger. Also, since the flow of the hydrogen off-gas discontinues or changes in the pulse manner, the effect of the catalyst is unstable.

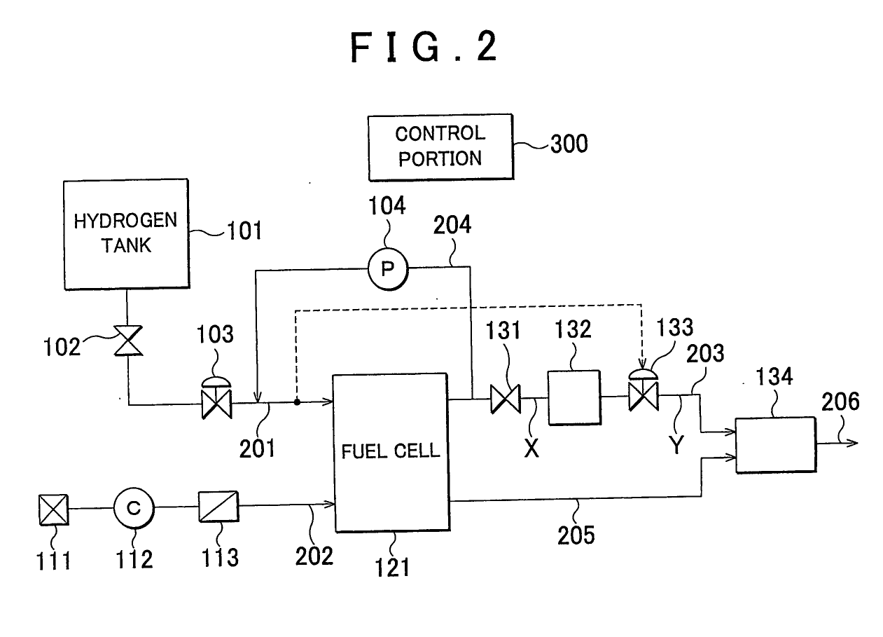

FIG. 2 shows a second embodiment. In FIG. 2, the same portions as in FIG. 1 are denoted by the same reference numerals, and description thereof will be omitted.

In the embodiment, as the flow quantity control valve (adjusting valve) 133, a diaphragm type mechanical valve is used. The pressure of the hydrogen gas supplied to the fuel cell 121 is applied to a diaphragm of the flow quantity control valve 133 as pilot pressure, and the opening amount of the flow quantity control valve 133 is controlled according to the flow quantity (pressure) of the supplied hydrogen gas. The other portions are the same as in the first embodiment.

In the configuration, when the control portion 300 opens the pressure adjusting valve 103 according to an increase in the required load such that the quantity of the hydrogen gas supplied to the fuel cell 121 is increased and the quantity of generated electric power is increased, the quantity of the hydrogen off-gas discharged form the fuel cell 121 to the hydrogen off-gas passage (exhaust passage) is increased (i.e., the peak discharge quantity and the number of discharges are increased). The pressure in the hydrogen supply passage 201 is transmitted to the diaphragm of the flow quantity adjusting valve 133 as the pilot pressure, and the flow quantity of the hydrogen off-gas from the flow quantity adjusting valve 133 is increased. Thus, the average value (substantially constant value) of the quantity of the hydrogen off-gas supplied to the combustor 134 is increased according to an increase in the quantity of the hydrogen gas supplied to the fuel cell 121.

Thus, it is possible to change the quantity of the hydrogen off-gas supplied to the combustor 134 according to an increase in the hydrogen off-gas discharged from the fuel cell 121, and to perform the combustion treatment. In this case as well, since the averaged (substantially constant) quantity of the hydrogen off-gas is supplied to the catalyst, the effect of the catalyst becomes stable.

### Third Embodiment

FIG. 3 shows a third embodiment of the invention. In FIG. 3, the same portions as in FIG. 1 are denoted by the same reference numerals, and description thereof will be omitted.

In the embodiment, as the flow quantity control valve (adjusting valve) 133, an electromagnetic valve is used, and is controlled by output of the control portion 300. The other portions are the same as in the first embodiment.

In the configuration, the control portion 300 sets the opening amount of the adjusting valve 103 according to the accelerator opening amount of the vehicle so as to set the quantity of the hydrogen gas supplied to the fuel cell 121. Also, the control portion 300 sets the average value of the quantity of the hydrogen off-gas supplied to the combustor 134 from the flow quantity adjusting valve 133 according to the accelerator opening amount of the vehicle. Thus, it is possible to set the quantity of the hydrogen off-gas supplied to the combustor 134 according to the quantity of the hydrogen off-gas discharged from the fuel cell 121.

In this case as well, since the averaged (substantially constant) quantity of the hydrogen off-gas is supplied to the catalyst, the effect of the catalyst becomes stable.

An electromagnet of the flow quantity adjusting valve 133 may be driven by amplifying power of an electric signal indicating the accelerator opening amount without using the control portion 300.

### Fourth Embodiment

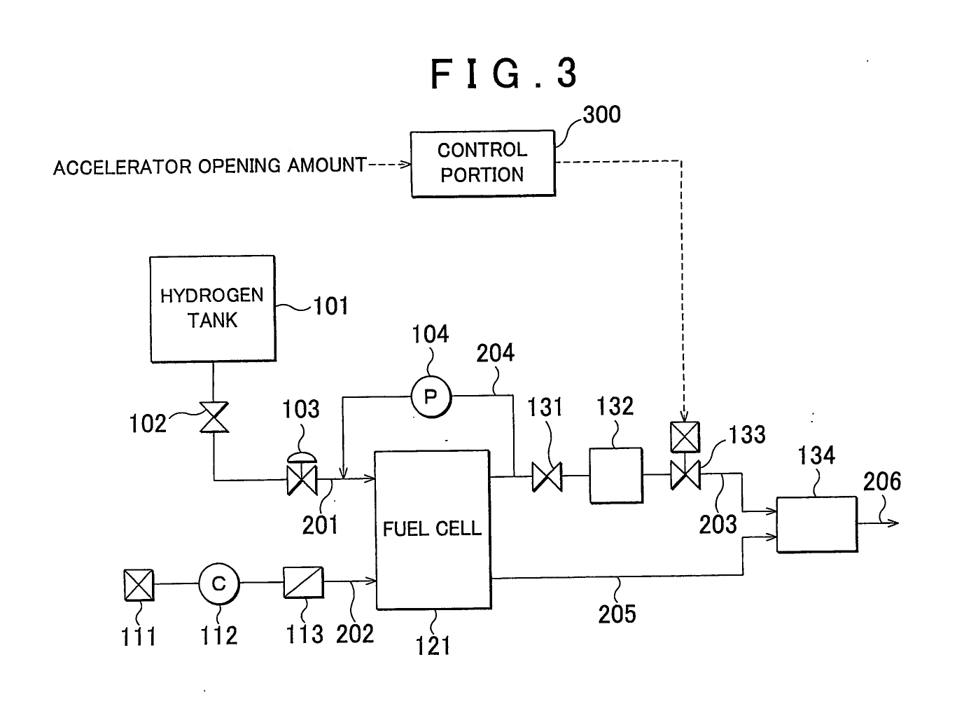

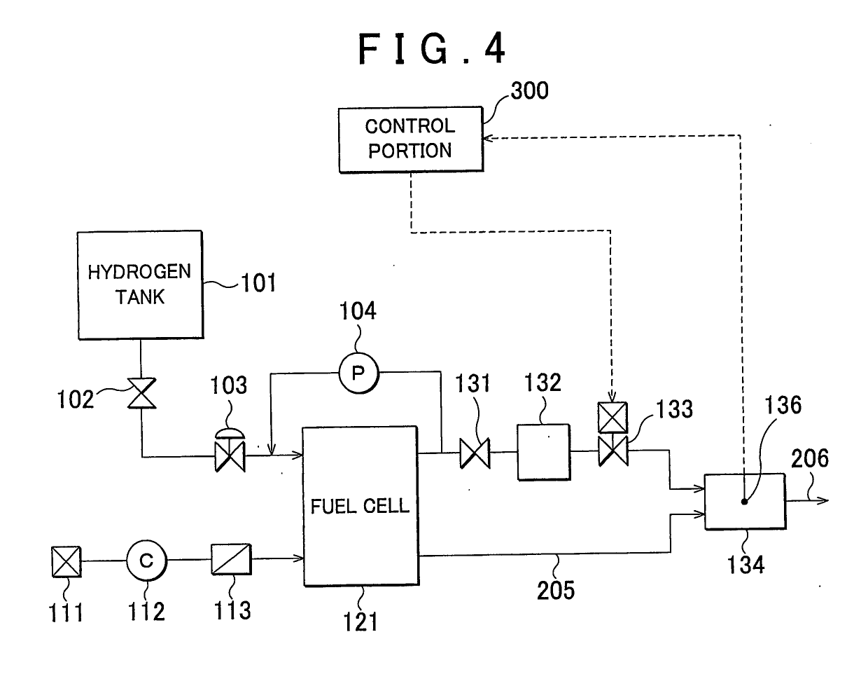

FIG. 4 shows a fourth embodiment of the invention. In FIG. 4, the same portions as in FIG. 1 are denoted by the same reference numerals, and description thereof will be omitted.

In the embodiment, a temperature sensor 136 for measuring the temperature of the catalyst in the combustor 134 is provided. Output of the temperature sensor 136 is transmitted to the control portion 300. The flow quantity control valve (adjusting valve) 133 for suppressing the pulsed change in the quantity of the hydrogen off-gas and supplying the hydrogen-off gas to the combustor 134 is constituted by an electromagnetic valve. Also, a sufficient quantity of the air off-gas is supplied to the combustor 134. The other portions are the same as in the first embodiment.

In the configuration, the control portion 300 adjusts the quantity of the hydrogen off-gas supplied from the flow quantity control valve 133 based on the output of the temperature sensor 136 such that the temperature of the catalyst in the combustor 134 becomes an appropriate value. That is, when the temperature of the catalyst is high, the opening amount of the flow quantity control valve 133 is decreased such that the quantity of the hydrogen subjected to the combustion treatment is decreased. When the temperature of the catalyst is low, the flow quantity control valve 133 is opened such that the quantity of the hydrogen subjected to the combustion treatment is increased. In each of the cases, the flow quantity control valve 133 suppresses the pulsed change in the quantity of the hydrogen off-gas, and supplies the substantially constant quantity of the hydrogen off-gas to the combustor 134.

In this case as well, since the averaged (substantially constant) quantity of the hydrogen off-gas is supplied to the catalyst, the effect of the catalyst becomes stable. Since the temperature of the catalyst is maintained at the optimum temperature, the effect of the catalyst is sufficiently obtained, and hydrogen combustion efficiency is high.

### Fifth Embodiment

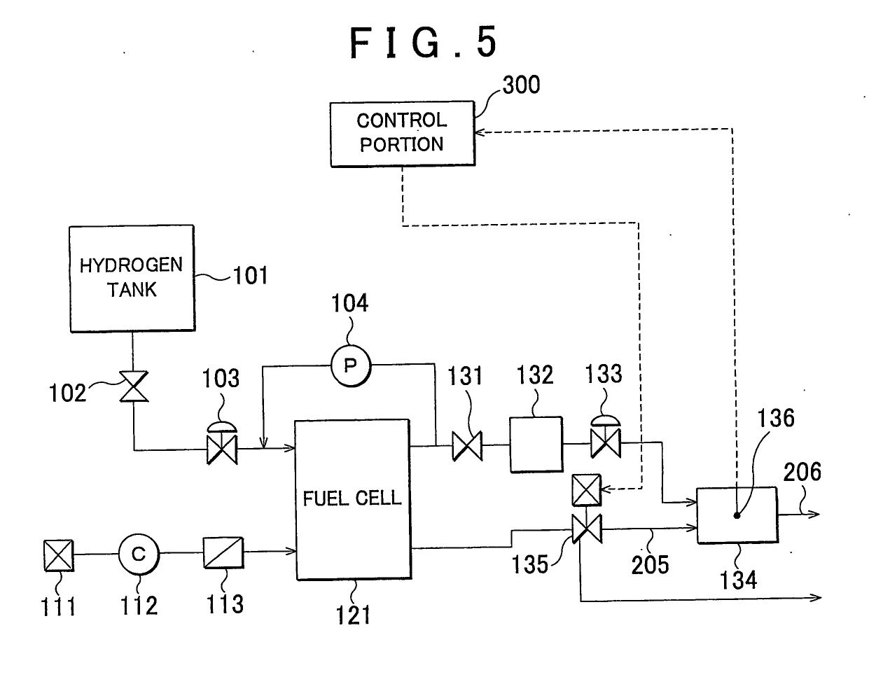

FIG. 5 shows a fifth embodiment of the invention. In FIG. 5, the same portions as in FIG. 1 are denoted by the same reference numerals, and description thereof will be omitted.

In the embodiment, the temperature sensor 136 for detecting the temperature of the catalyst is provided in the combustor 134. Also, an electromagnetic valve 135 for adjusting the flow quantity of the air off-gas is provided in the air off-gas passage 205. The other portions are the same as in the first embodiment.

In the configuration, the flow quantity control valve (adjusting valve) 133 is a mechanical adjusting valve or an electromagnetic adjusting valve. As in the aforementioned first to third embodiments, the quantity of the hydrogen off-gas supplied to the combustor 134 is adjusted according to the load quantity or the quantity of the hydrogen gas supplied to the fuel cell 121. At this time, the pulsed change in the quantity of the hydrogen off-gas is suppressed by the flow the flow control valve 133. The control portion 300 adjusts the quantity of the air off-gas supplied from the flow quantity control valve 135 based on the output of the temperature sensor 136 such that the temperature of the catalyst in the combustor 134 becomes an appropriate value. That is, when the temperature of the catalyst in the combustor 134 is high, the flow quantity control valve 135 is opened, the air off-gas whose quantity is excess with respect to the quantity of the hydrogen off-gas is supplied, heat is removed from the catalyst, and therefore the temperature of the catalyst is decreased. When the temperature of the catalyst is low, the opening amount of the flow quantity control valve 135 is decreased such that the flow quantity of the air off-gas is decreased and the quantity of heat removed from the catalyst is decreased. Also, the supply quantity of the air off-gas is set to an appropriate value with respect to the supply quantity of the hydrogen-off gas.

Thus, the temperature of the catalyst is adjusted to the optimum value for obtaining the effect of the catalyst.

### Sixth Embodiment

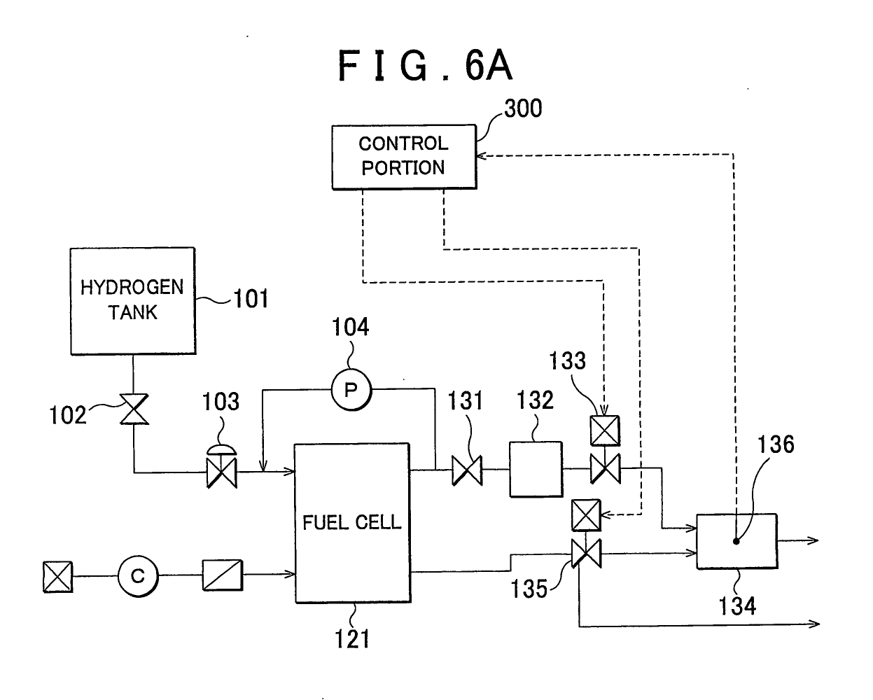

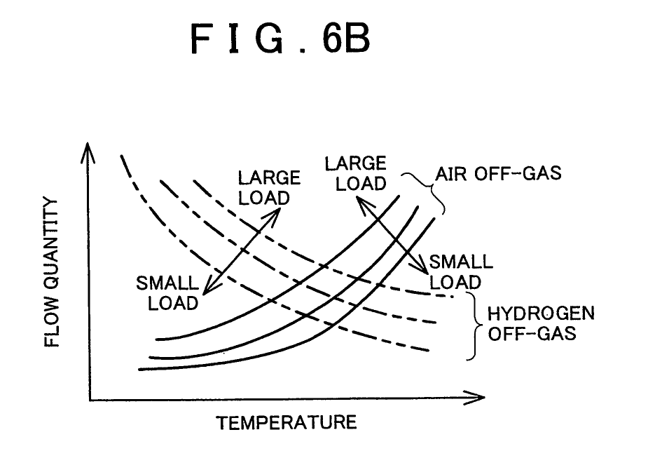

FIG. 6A shows a sixth embodiment of the invention. In FIG. 6A, the same portions as in FIG. 1A are denoted by the same reference numerals, and description thereof will be omitted.

In the embodiment, the temperature sensor 136 for detecting the temperature of the catalyst is provided in the combustor 134. The flow quantity control valve 133 for suppressing the pulsed change in the flow quantity is constituted by an electromagnetic valve. Also, the electromagnetic valve 135 for adjusting the flow quantity of the air off-gas is provided in the air off-gas passage 205. The other portions are the same as in the first embodiment.

In the configuration, the control portion 300 adjusts the flow quantity control valve 133 and the flow quantity control valve 135 based on the output of the temperature sensor 136 such that the temperature of the catalyst in the combustor 134 becomes an appropriate value, and sets the supply quantities of the hydrogen off-gas and the air off-gas. The control portion 300 stores, in advance, a relation between the temperature of the catalyst in the combustor 134 to be detected and the supply quantities of the hydrogen off-gas and the air off-gas to be adjusted, as data in the memory thereof.

FIG. 6B schematically shows an example of the quantity of the hydrogen off-gas and the quantity of the air off-gas that are set with respect to the required load (the supply quantity of the hydrogen gas) and the temperature of the catalyst. The control portion 300 selects and sets operating characteristics of the flow quantity control valve 133 according to the supply quantity of the hydrogen gas. When the temperature of the catalyst in the combustor 134 is higher than an appropriate value, the opening amount of the flow quantity adjusting valve 133 is decreased according to the operating characteristics such that the supply quantity of the hydrogen off-gas is decreased. Also, the control portion 300 selects and sets operating characteristics of the flow quantity adjusting valve 135 according to the supply quantity of the hydrogen gas. When the temperature of the catalyst in the combustor 134 is higher than an appropriate value, the flow quantity adjusting valve 135 is opened according to the operating characteristics such that the quantity of the air off-gas is increased. Meanwhile, when the temperature of the catalyst is lower than the appropriate value, the flow quantity adjusting valve 133 is opened according to the selected operating characteristics such that the supply quantity of the hydrogen off-gas is increased. In addition, the opening amount of the flow quantity adjusting valve 135 is decreased according to the selected operating characteristics such that the quantity of the air off-gas is decreased.

Thus, it is possible to maintain the temperature of the catalyst at the optimum temperature and to efficiently perform the combustion treatment for the hydrogen off-gas by adjusting the flow quantity of the hydrogen off-gas and the flow quantity of the air off-gas according to the temperature of the catalyst in the combustor 134.

### Seventh Embodiment

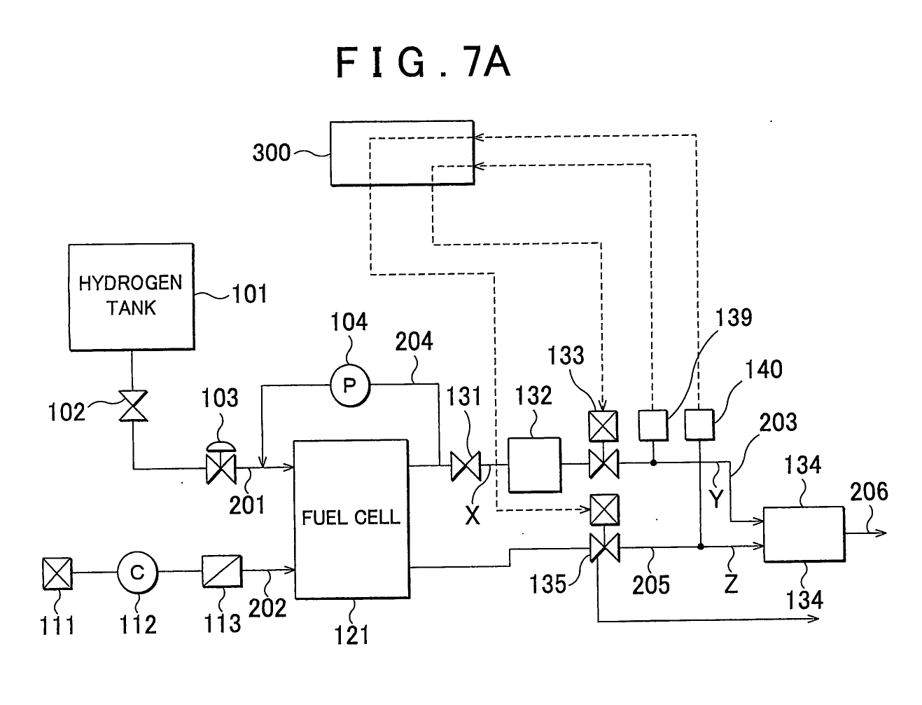

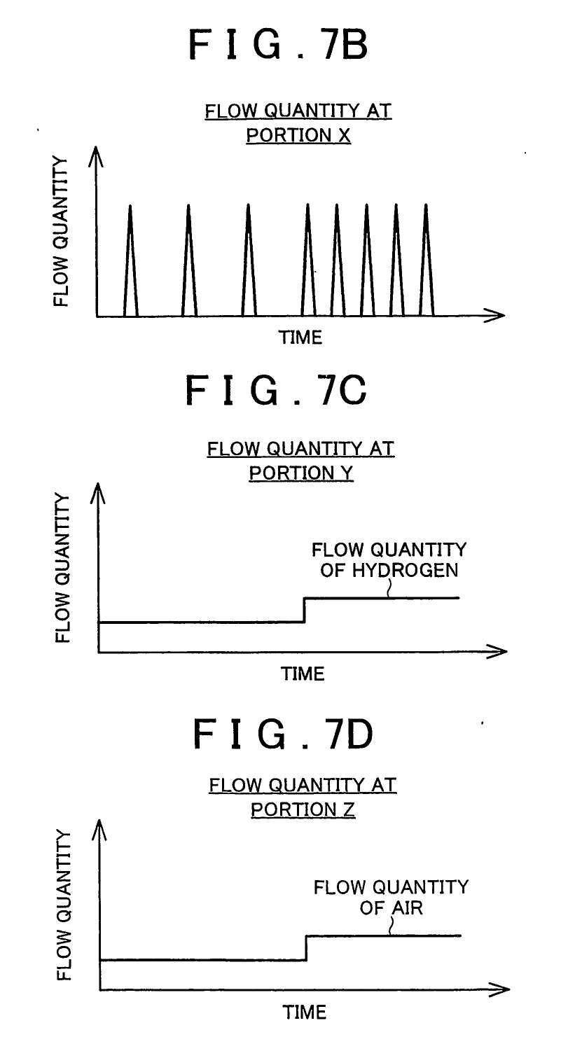

FIG. 7A to FIG. 7D show a seventh embodiment of the invention. In FIG. 7A, the same portions as in FIG. 1A are denoted by the same reference numerals, and description thereof will be omitted.

In the embodiment, the air-fuel ratio between the hydrogen gas and the oxygen (air) at the catalyst portion is maintained at the optimum value. Accordingly, the electromagnetic flow quantity control valve 133 and a hydrogen sensor (fluid state sensor) 139 for detecting the flow quantity of the hydrogen off-gas and a concentration of hydrogen in the hydrogen off-gas are provided between the chamber 132 and the combustor 134. Also, the electromagnetic flow quantity control valve 135 and an oxygen sensor (fluid state sensor) 140 for detecting the flow quantity of the oxygen off-gas and a concentration of oxygen in the oxygen off-gas are provided in the air off-gas passage 205 between the fuel cell 121 and the combustor 134. The output of the hydrogen sensor 139 and the output of the oxygen sensor 140 are supplied to the control portion 300. The other portions are the same as in the first embodiment.

In the configuration, the control portion 300 adjusts the flow quantity control valve 133 having a function of suppressing, at the portion X, the pulsed change in the flow quantity of the hydrogen off-gas that is intermittently discharged from the opening/closing valve 131 (refer to FIG. 7B), thereby controlling the flow quantity of the hydrogen off-gas at the portion Y to the substantially constant flow quantity (the average value) as shown in FIG. 7C. At this time the control portion 300 determines the quantity of hydrogen in the hydrogen off-gas based on the output of the hydrogen sensor 139. Then, the control portion 300 adjusts the flow quantity control valve 135, thereby adjusting the flow quantity of the oxygen (air off-gas) at the portion Z such that the optimum air-fuel ratio with respect to the flow quantity of the hydrogen is obtained, as shown in FIG. 7D. The flow quantity of the oxygen is adjusted by controlling the flow quantity control valve 135 such that the ratio between the output of the oxygen sensor 140 and the flow quantity of the hydrogen becomes equal to a predetermined air-fuel ratio.

Thus, it is possible to perform the combustion treatment for the remaining hydrogen with the air-fuel ratio in the catalyst being the optimum value.

### Eighth Embodiment

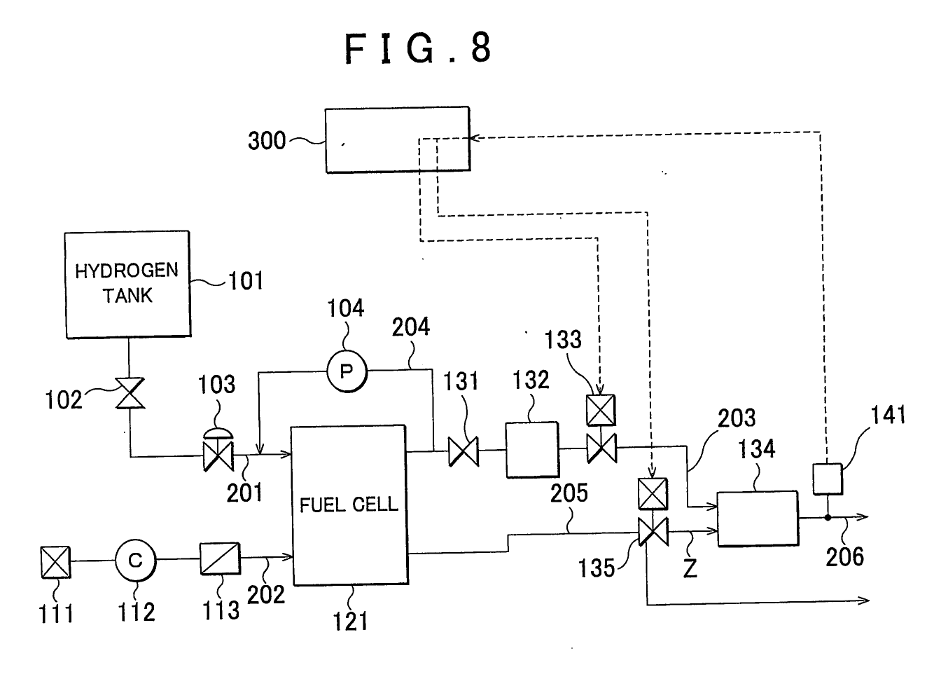

FIG. 8 shows an eighth embodiment of the invention. In FIG. 8, the same portions as in FIG. 1 are denoted by the same reference numerals, and description thereof will be omitted.

In the embodiment, a hydrogen sensor 141 is provided in the outside exhaust passage 206 extending from the combustor 134. The hydrogen sensor 141 detects the concentration of the remaining hydrogen (the quantity of hydrogen) in the gas discharged to the atmosphere. The result of detection is output to the control portion 300. The flow quantity control valve 133 is provided in the hydrogen off-gas passage 203 between the chamber 132 and the combustor 134. Also, the electromagnetic flow quantity control valve 135 is provided in the air off-gas passage 205 between the fuel cell 121 and the combustor 134. The other portions are the same as in the first embodiment.

In the configuration, the control portion 300 controls the flow quantity control valves 133 and 135 so as to remove remaining hydrogen when there is remaining hydrogen in the exhaust passage extending from the combustor 134, and sets the flow quantities of the hydrogen off-gas and the air off-gas, the ratio between the hydrogen off-gas and the air off-gas, the temperature of the catalyst, and the like. Thus, it is possible to avoid a situation where the hydrogen is discharged to the atmosphere without being purified.

### Ninth Embodiment

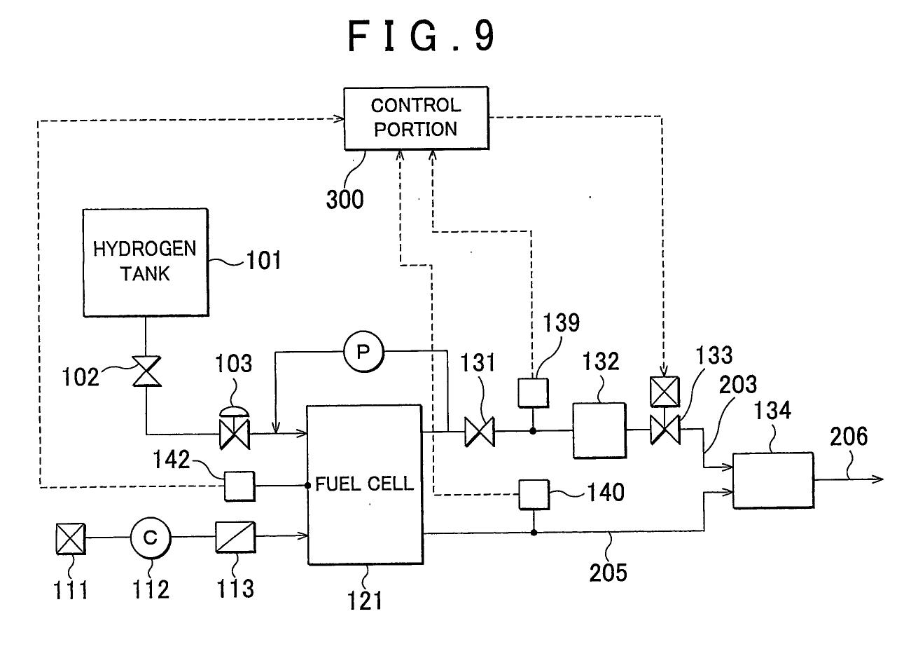

FIG. 9 shows a ninth embodiment of the invention. In FIG. 9, the same portions as in FIG. 1 are denoted by the same reference numerals, and description thereof will be omitted.

In the embodiment, the flow quantity control valve (adjusting valve) 133 is controlled focusing on an operating parameter based on which the quantity of the hydrogen supplied to the fuel cell 121 can be estimated. Accordingly, the electromagnetic flow quantity control valve 133 is provided between the chamber 132 and the combustor 134. The hydrogen sensor 139 is provided between the opening/closing valve 131 and the chamber 132. Also, the oxygen sensor 140 is provided in the air off-gas passage 205 between the fuel cell 121 and the combustor 134. An operating state sensor 142 is provided for the fuel cell 121. The operating state sensor 142 detects the operating parameter of the fuel cell 121 (the supply quantity of the hydrogen, an actual electric power generation quantity, and the like). The operating state sensor 142 may detect a required electric power generation quantity which is an operating parameter of the fuel cell 121 based on output of an accelerator opening amount sensor. The output of the hydrogen sensor 139, the output of the oxygen sensor 140, the output of the operating state sensor 142 are supplied to the control portion 300. The other portions are the same as in the first embodiment. In the configuration, the control portion 300 can perform the following three control modes.

(1) The control portion 300 controls the flow quantity control valve 133 based on an output value of the hydrogen sensor 139 such that the flow quantity of the hydrogen off-gas becomes substantially constant.

(2) In addition to the aforementioned control of the valve described in (1), the control portion 300 controls the flow quantity control valve 133 based on the output of the hydrogen sensor 139 and the output of the oxygen sensor 140 such that the ratio between the hydrogen gas and the oxygen gas in the combustor 134 becomes an appropriate air-fuel ratio.

(3) In addition to the aforementioned control of the valve described in (1), the control portion 300 detects the quantity of the hydrogen gas supplied to the fuel cell 121 and the electric power generation quantity based on the operating parameter obtained from the operating state of the fuel cell 121 directly or indirectly, thereby estimating the quantity of the hydrogen off-gas that is discharged from the fuel cell 121 to the outside periodically and/or the concentration of hydrogen in the hydrogen off-gas. The flow quantity of the hydrogen off-gas supplied from the flow quantity control valve 133 may be set based on the estimated quantity of the hydrogen off-gas discharged from the fuel cell 121 and/or the concentration of hydrogen in the hydrogen off-gas.

In the embodiment, it is possible to detect or estimate the quantity of the hydrogen supplied to the fuel cell 121 based on the operating parameter obtained during operation of the fuel cell 121. Further, it is possible to estimate the quantity of the hydrogen off-gas discharged from the fuel cell 12 and/or the concentration of hydrogen in the hydrogen off-gas, and to set the flow quantity of the hydrogen off-gas supplied from the flow quantity control valve 133.

### Tenth Embodiment

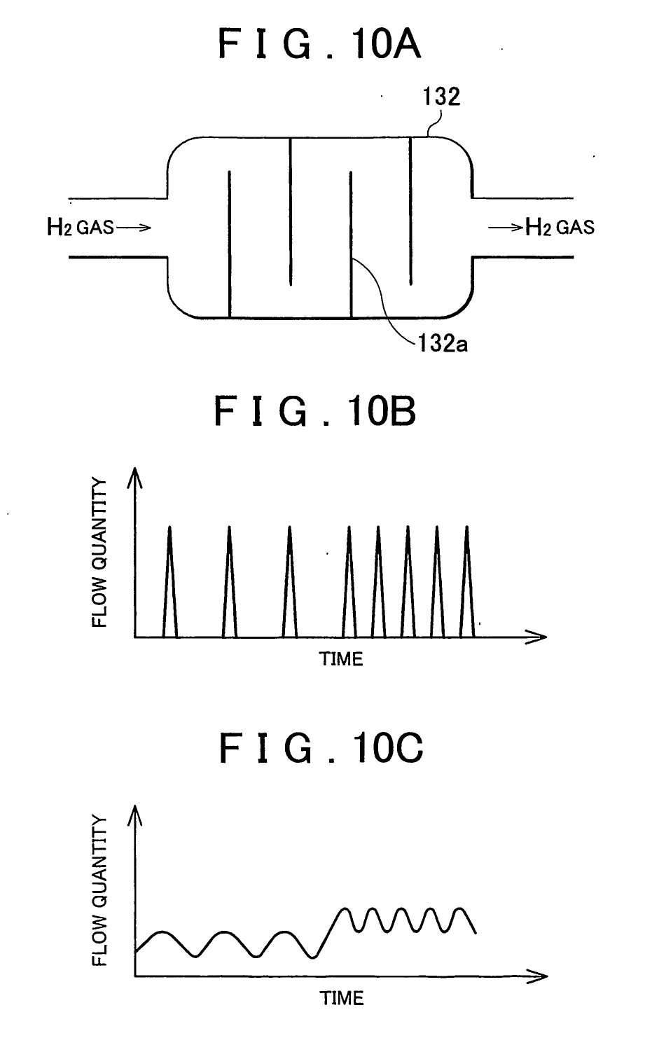

FIG. 10 shows a tenth embodiment of the invention. In the embodiment, the fluctuation of the flow quantity or the pressure of the hydrogen off-gas passing through the flow quantity control valve (adjusting valve) 133 is suppressed (smoothed) in advance by modifying the structure of the chamber 132 employed in each of the aforementioned embodiments. When the fluctuation of the pressure of the hydrogen off-gas flowing to the flow quantity adjusting valve 133 is small, the structure of the flow quantity adjusting valve 133 can be simple. Also, a workload (capability) of suppressing the pulsed change in the flow quantity adjusting valve 133 can be reduced.

As shown in FIG. 10A, plural partitions 132a are provided in the chamber 132. The inside of the chamber 132 is partitioned into plural chambers which communicate with each other. Thus, the length of the passage of the hydrogen off-gas is increased, and the hydrogen off-gas is diffused to each of the chambers, whereby the gas concentration and the gas pressure are made uniform.

FIG. 10B schematically shows the flow quantity of the hydrogen off-gas flowing into the chamber 132. FIG. 10C schematically shows the flow quantity of the hydrogen off-gas flowing out of the chamber 132. The pulsed flow of the hydrogen off-gas discharged from the opening/closing valve 131 is smoothed by the chamber 132. Accordingly, it is expected to reduce the workload of suppressing the pulsed change in the flow quantity control valve (adjusting valve) 133 that is disposed in the stage subsequent to the chamber 132. Also, the flow quantity adjusting valve may be constituted by a throttle valve.

### Eleventh Embodiment

In each of the first to the ninth embodiments, the flow quantity adjusting valve 133 is adjusted based on the control signal from the control portion 300, whereby the concentration of hydrogen in the hydrogen off-gas discharged through the outside exhaust passage 206 is controlled. Although the control using the flow quantity adjusting valve 133 has an advantage that the flow quantity and the pressure can be adjusted continuously (in an analog manner), the flow quantity control valve 133 has a complicated structure, and is expensive. Also, the control signal output from the control portion 300 contains multivalued information, and a level signal (analog signal) needs to be supplied, which increases the workload of the calculation operation.

In the eleventh embodiment, the aforementioned function of the flow quantity adjusting valve 133 is achieved using plural electromagnetic opening/closing valves which have a simpler structure and are less expensive. The plural opening/closing valves are connected in parallel, and diameters of passages (or resistance of the passages) are equivalently changed due to on/off control (control of opening/closing of the valves) performed by the control portion. Thus, the quantity of the hydrogen off-gas flowing in the passages is adjusted, whereby the concentration of hydrogen in the hydrogen off-gas discharged from the flow quantity adjusting valve 133 is reduced and uniformized.

FIG. 12 shows the eleventh embodiment of the invention. In FIG. 12, the same portions as in FIG. 1 are denoted by the same reference numerals, and description thereof will be omitted.

In the embodiment, there are provided a dilution air supply passage 207, a pressure adjusting valve 209, a mixing portion (chamber) 231, electromagnetic opening/closing valves 232, 233, 235, a muffler (silencer) 234, and a pressure sensor 240. As described above, the hydrogen off-gas discharged from the fuel cell 121 is returned to an inlet side of the fuel cell 121 through the hydrogen off-gas circulation passage, and is reused. Part of the hydrogen off-gas is discharged to the outside of the fuel cell 121 by the purge valve 131. The discharged hydrogen off-gas is guided to a first inlet of the mixing portion 231 through the hydrogen off-gas passage 203. Also, the air off-gas discharged from the fuel cell 121 is guided to the muffler 234 through the pressure adjusting valve 209 and the air off-gas passage 205. The quantity of air supplied to the fuel cell 121 is adjusted by the compressor 112 and the pressure adjusting valve 209. Air for dilution is supplied to a second inlet of the mixing portion 231 from an outlet portion of the compressor 112 through the opening/closing valve 235 and the dilution air supply passage 207. The outlet of the mixing portion 231 is connected to the air off-gas passage 205 through outlet passages (exhaust passages) 211 and 212. The opening/closing valve 232 is provided in the outlet passage 211, and the opening/closing valve 233 is provided in the outlet passage 212. The opening/closing valves 232 and 233 function as pressure adjusting valves (adjusting valves) as described later.

The mixing portion 231 is a chamber having a capacity sufficient for temporarily storing gas. In the mixing portion 231, the hydrogen off-gas and supplied new air are mixed to dilute the hydrogen off-gas, and to reduce the concentration of hydrogen in the hydrogen off-gas. The gas pressure inside the mixing portion 231 is detected by the pressure sensor 240. The detected pressure is transmitted to the control portion 300 as a detection signal. The mixing portion 231 may be formed by configuring part of the hydrogen off-gas passage 203 using a large-diameter pipe.

The hydrogen off-gas (diluted gas) that is diluted in the mixing portion 231 is mixed with the air off-gas in the air off-gas passage 205 through at least one of the outlet passages 211 and 212 according to the state of each of the opening/closing valves 232 and 233. Thus, the hydrogen off-gas is further diluted. A portion at which the outlet passages 211 and 212 and the air off-gas passage 205 are connected serves as a confluence portion 205a. The diluted gas is guided to the muffler 234, whereby the fluctuation of the pressure is reduced, and noise is reduced. The muffler 234 can be replaced by the aforementioned combustor 134. The combustion treatment for the hydrogen is performed using the (platinum) catalyst in the combustor 134, and the quantity of the hydrogen discharged to the outside of the fuel cell system can be reduced. Then, the concentration of the remaining hydrogen in the hydrogen off-gas becomes sufficiently low, the temperature of the hydrogen off-gas is decreased, and the hydrogen-off gas is discharged to the atmosphere. The other portions are the same as in FIG. 1.

In the aforementioned configuration, the outlet passages 211 and 212 are connected to the air off-gas passage 205, which is connected to the muffler 234. However, the outlet passages 211 and 212 may be connected to the muffler 234, and the confluence portion 205a may be the muffler. Also, the flow quantity or pressure of the air in the dilution air supply passage 207 can be adjusted more easily by employing a valve whose opening amount can be adjusted (a flow quantity control valve or a pressure adjusting valve) as the opening/closing valve 235.

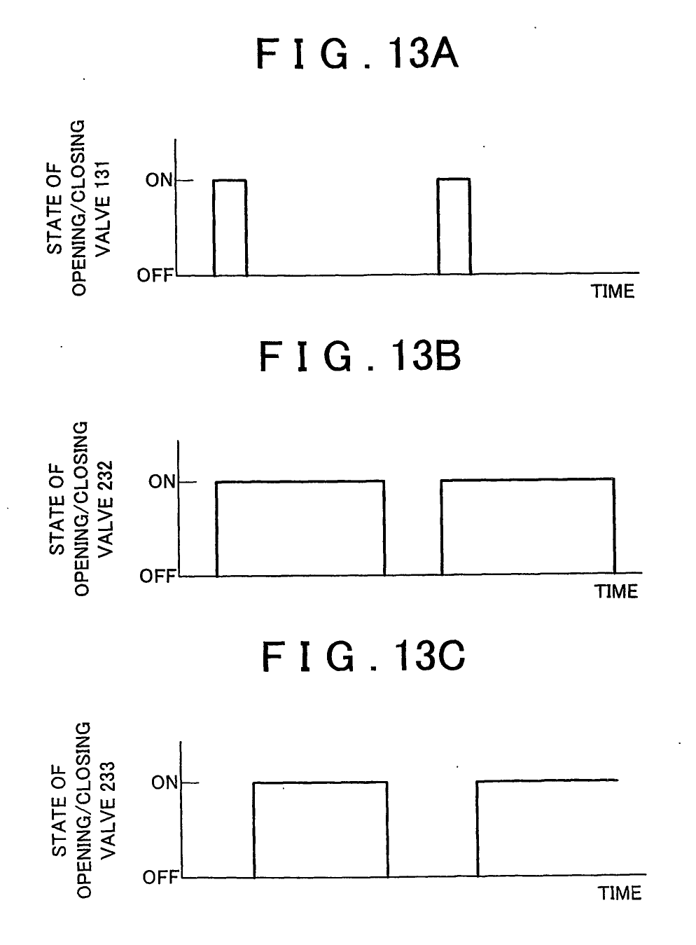

Next, referring to FIGS. 13A to 13C, an example of operation in the eleventh embodiment will be described. FIG. 13A to 13C are an operation timing diagram in which a horizontal axis indicates elapsed time, and a vertical axis indicates the state of the opening/closing valve, i.e., the opening state (ON state) and the closing state (OFF state). FIG. 13A indicates the state of the opening/closing valve 131. FIG. 13B indicates the state of the opening/closing valve 232. FIG. 13C indicates the state of the opening/closing valve 233.

As shown in FIG. 13A, when the control portion 300 opens the opening/closing valve 131, the pressure in the mixing portion 231 is sharply increased in an early stage during the opening time period of the opening/closing valve 131. Thus, the quantity of the hydrogen off-gas flowing to the air off-gas passage 205 from the mixing portion 231 is increased. Therefore, the control portion 300 opens only the opening/closing valve 232 through which the diluted gas is discharged, and the quantity of the hydrogen gas flowing into the air off-gas passage 205 is reduced (FIG. 13B). After the control portion 300 closes the opening/closing valve 131, the pressure in the mixing portion 231 is reduced. The control portion 300 opens the opening/closing valves 232 and 233 in order to discharge the diluted gas that remains in the mixing portion 231 to the air off-gas passage 205 (FIG. 13C). Since the flow quantity of the diluted gas supplied from each of the opening/closing valves 232 and 233 is controlled according to the change in the pressure of the hydrogen off-gas downstream of the opening/closing valve (hydrogen off-gas discharge valve) 131 in this manner, the peak value of the concentration of the hydrogen discharged to the outside of the vehicle is reduced.

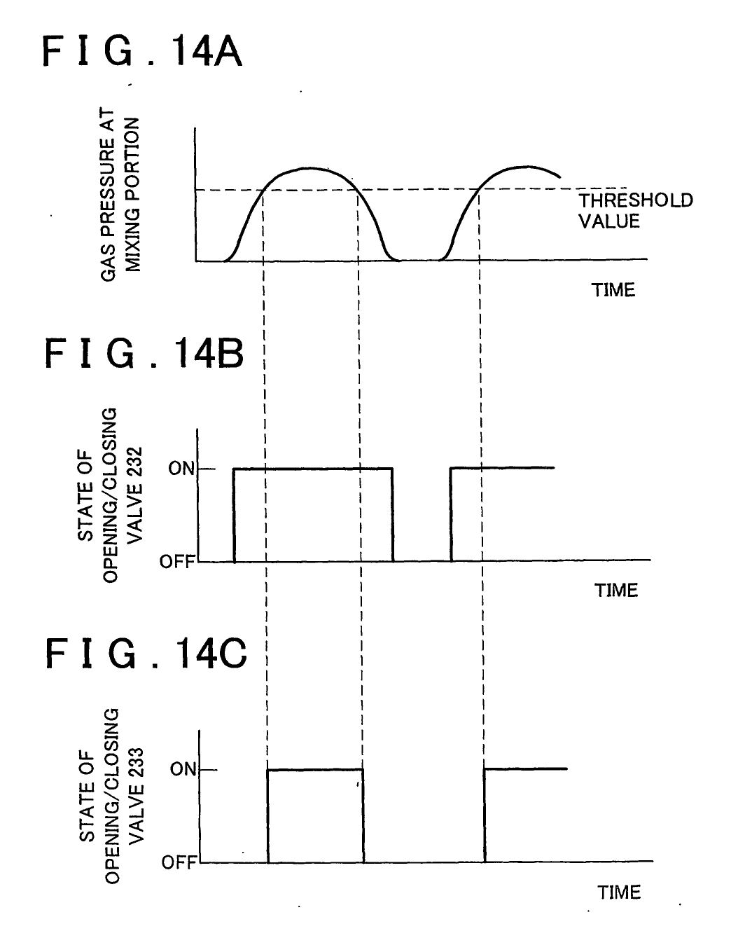

Next, referring to FIGS. 14A to 14C, another example of control operation for the opening/closing valve 232 and the opening/closing valve 233 will be described. In the embodiment, the pressure sensor 240 provided for the mixing portion 231 is used.

When the detection signal from the pressure sensor 240 shown in FIG. 14A is equal to or higher than a threshold value, that is, the gas pressure in the mixing portion 231 is equal to or higher than predetermined pressure, both of the opening/closing valves 232 and 233 are opened as shown in FIG. 14B and FIG. 14C. When the detection signal from the pressure sensor 240 is lower than the threshold value, that is, the gas pressure in the mixing portion 231 is lower than the predetermined pressure, only the opening/closing valve 232 is opened, and the opening/closing valve 233 is closed as shown in FIG. 14B and FIG. 14C. Accordingly, the pulsed change in the flow quantity of the gas discharged from the mixing portion 231 is reduced, and the same effects as the aforementioned effects can be obtained. Thus, each of the opening/closing valves 232 and 233 is separately controlled according to the pressure state upstream of the opening/closing valves 232 and 233.

In the embodiment, two opening/closing valves for discharging the gas are provided for the mixing portion 231. However, three opening/closing valves for discharging the gas may be provided for the mixing portion 231. Such plural opening/closing valves can be controlled by the control portion 300. For example, when the pressure detected by the pressure sensor 240 is higher than predetermined pressure, the opening/closing valves may be sequentially opened until the detected pressure reaches the predetermined pressure, and cross section areas of the hydrogen off-gas discharge passages extending from the outlet of the mixing portion 231 may be enlarged so that the hydrogen off-gas at the predetermined pressure is discharged.

Also, the cross section areas of the plural hydrogen off-gas discharge passages extending from the outlet of the mixing portion 231 are not necessarily the same. For example, in the case where plural opening/closing valves are provided, and the basic cross sectional area thereof is 1 and the cross sectional area thereof is increased so as to be the power of 2 (that is, two opening/closing valves each having a cross sectional area of 1, one opening/closing valve having a cross sectional area of 2, and one opening/closing valve having a cross sectional area of 4 are provided), a cross sectional area of a portion through which the hydrogen-off gas discharged from the mixing portion 231 passes can be substantially continuously adjusted with smoothness corresponding to the number of the opening/closing valves, by controlling opening (ON)/closing (OFF) of the plural opening/closing valves. Thus, it is possible to obtain the effect of adjusting the pressure that is substantially the same as that of the pressure adjusting valve.

Further, when the opening/closing valve 235 that is provided between the downstream (output side) of the air compressor 112 and the mixing portion 231 is opened, air from the air compressor 112 is guided into the mixing portion 231. Therefore, in the case where the hydrogen off-gas is not sufficiently diluted, or in the case where hydrogen is oxidized using the catalyst in the muffler 234, it is possible to compensate for the shortage of the oxygen quantity. In the case where the opening/closing valve 235 is opened when all of the opening/closing valves 131, 232, 233 are closed, it is possible to reduce the influence of the opening of the opening/closing valve 235 on the pulsed change in the flow quantity of the mixed gas discharged from the mixing portion 231 as compared with the case where the opening/closing valve 235 is opened when one of the opening/closing valves 232 and 233 is opened. However, the invention is not limited to the case where the opening/closing valve 235 is opened only when all of the opening/closing valves 131, 232 233 are closed.

Also, the opening/closing amount of the opening/closing valves 232 and 233 may be adjusted through the control portion 300 according to the opening state of the opening closing valve 131 that is the hydrogen purge valve, without using the pressure sensor 240. For example, in both the case where the opening/closing valve 131 is opened for the predetermined opening time period, and the cycle from when the opening/closing valve 131 is closed until when the opening/closing valve 131 is opened next time is changed, and the case where the cycle is constant, and the opening time period of the opening/closing valve 131 per unit cycle is changed, the opening/closing valves 232 and 233 that are flow quantity adjusting means are appropriately opened according to the proportion of the opening time period of the opening/closing valve 131 per unit time, whereby the flow quantity can be adjusted. For example, as the proportion of the opening time period of the opening/closing valve 131 is larger, the opening/closing valves 232 and 233 are opened to a larger degree, whereby the pressure of the hydrogen off-gas in the mixing portion 231 can be made substantially constant without providing a specific sensor. Thus, it is possible to suppress the pulsed flow of the hydrogen off-gas supplied to the muffler (or the combustor) 234, and to adjust the quantity of the discharged hydrogen off-gas at the same time. This operation can be performed since the control portion 300, which performs the control of the opening state of the opening/closing valve 131, that is, performs the control to decide whether to open or close the opening/closing valve 131, detects the opening state of the opening/closing valve 131, and generates a signal for controlling the opening/closing amount of the flow quantity adjusting valve 133.

### Twelfth Embodiment

In each of the first to the ninth embodiments and the eleventh embodiment, the gas pressure (positive pressure) is applied from the upstream side to the downstream side of the hydrogen off-gas passage, whereby the hydrogen off-gas is guided to the chamber 132 or the mixing portion 231, and further the hydrogen off-gas is diluted or is subjected to the combustion treatment, and then hydrogen off-gas is discharged. In the embodiment, negative static pressure is formed in the mixing portion (chamber) 231, whereby the hydrogen off-gas is moved from the upstream side to the downstream side of the hydrogen off-gas passage. Then, the hydrogen off-gas is guided to the mixing portion 231 and is stored in the mixing portion 231, and the gas pressure in the mixing portion 231 is maintained at the same pressure as the gas pressure in the air off-gas passage (for example, approximately the normal pressure i.e., atmospheric pressure). Next, air is introduced into the mixing portion 231, the hydrogen off-gas is diluted, and the diluted hydrogen off-gas is discharged to the air off-gas passage. Thus, it is possible to suppress the pulsed change in the concentration of the hydrogen gas discharged to the outside of the vehicle, which is caused by the pulsed flow of the hydrogen off-gas discharged from the hydrogen off-gas circulation passage (i.e., it is possible to uniformize the concentration of the hydrogen gas discharged to the outside of the vehicle).

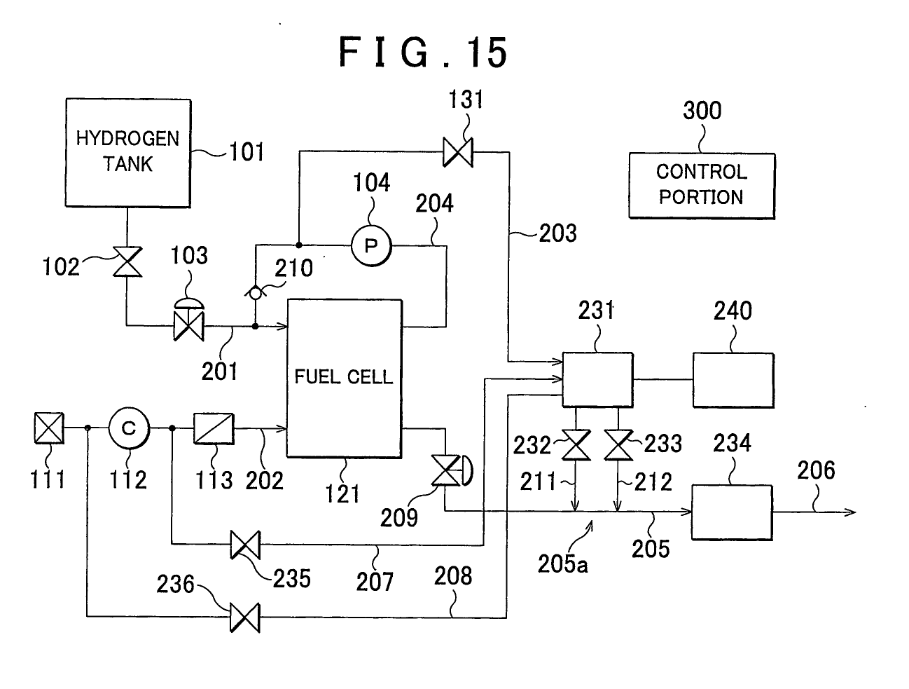

FIG. 15 shows the twelfth embodiment. In FIG. 15, the portions that are the same as in FIG. 12 are denoted by the same reference numerals, and description thereof will be omitted. The twelfth embodiment is the same as the eleventh embodiment except that a negative pressure forming passage 208 including the opening/closing valve 236 is further provided between the air supply passage 202 on the upstream side (intake side) of the air compressor 112 and the mixing portion 231. In the embodiment, the air off-gas passage 205 can be regarded as the first passage of the present invention. The hydrogen off-gas passage 203, the mixing portion 231, the outlet passages 211 and 212 can be regarded as the second passage of the present invention. The air compressor 112, the dilution air supply passage 207 and the negative pressure forming passage 208 can be regarded as the pressure adjusting means of the present invention. Also, the dilution air supply passage 207, the opening/closing valve 235, the negative pressure forming passage 208, and the opening/closing valve 236 can be regarded as the adjusting passage of the present invention. The adjusting passage serves as a portion of the second passage for diluting the hydrogen off-gas and discharging the diluted hydrogen off-gas, and is included in the second passage.

As described above, the pressure adjusting means includes, for example, the pump and the opening/closing valve. Also, the pressure adjusting means is connected to at least one of the first passage and the second passage. The pressure adjusting means may be connected to both of the first passage and the second passage. In the case where the pressure adjustment is performed, the pressure sensor is appropriately provided in one of the first passage, the second passage, and the confluence portion, and the pressure adjusting means adjusts a relation between the pressure of the hydrogen off-gas and the pressure of the gas for dilution at the confluence portion. The pressure value may be detected by detecting a relation between the pressure in the first passage and the pressure in the second passage, or by detecting a relative relation between the pressure in the first passage and the pressure in the second passage. The pressure adjustment is adjusting the quantity (concentration) of the hydrogen off-gas and that of the gas for dilution at the confluence portion. The concentration of hydrogen in the hydrogen off-gas is adjusted to be in a target dilution range by adjusting the quantity of the mixed gas. Other portions of the configuration are the same as in FIG. 12.

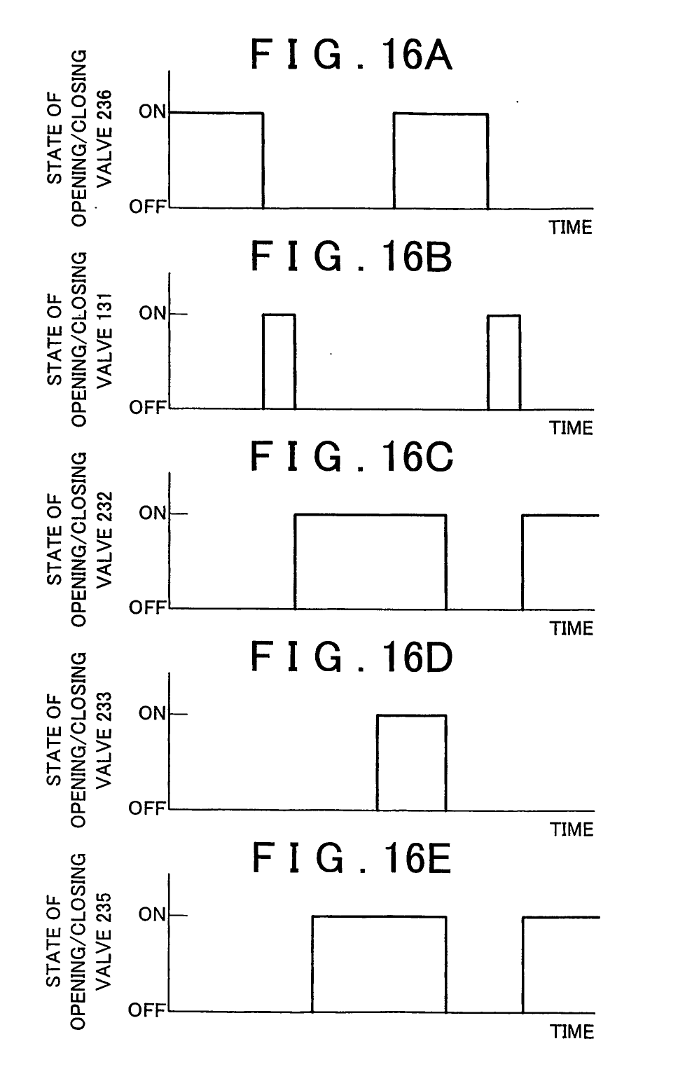

Next, referring to FIG. 16A to FIG. 16E, the control operation in the twelfth embodiment will be described. In FIG. 16A to FIG. 16E, a horizontal axis indicates elapsed time, and a vertical axis indicates the state of the opening/closing valve. FIG. 16A shows the state of the opening/closing valve 236. FIG. 16B shows the state of the opening/closing valve 131. FIG. 16C shows the state of the opening/closing valve 232. FIG. 16D shows the state of the opening/closing valve 233. FIG. 16E shows the state of the opening/closing valve 235. The control portion 300 performs the control described below when performing a purge operation for discharging the hydrogen off-gas to the outside of the fuel cell system.

(1) The control portion 300 opens the opening/closing valve 236, and closes the opening/closing valve 235, the opening/closing valve 131, the opening/closing valve 232, and the opening/closing valve 233 in an early state during the cycle for discharging the hydrogen off-gas to the outside (refer to FIG. 16A). In this state, the hydrogen-off gas passage 203 and the dilution air supply passage 207 that can introduce the gas into the mixing portion 231, and the outlet passages 211 and 212 are blocked. Since the gas passages through which the gas flows into and flows out of the mixing portion 231 are blocked, and the gas inside the mixing portion 231 is sucked through the negative pressure forming passage 208 using the air compressor 112 operating for generating electric power, the pressure inside the mixing portion 231 continues to be reduced.

(2) After the control portion 300 determines that the output signal of the pressure sensor 240 reaches a predetermined threshold value, that is, after the control portion 300 detects that the gas pressure in the mixing portion 231 is reduced to predetermined pressure, the control portion 300 closes the opening/closing valve 236. Thus, a static negative pressure is formed in the mixing portion 231.

(3) When the control portion 300 opens only the opening/closing valve 131, the hydrogen off-gas flows into the mixing portion 231 from the fuel cell 121 side (refer to FIG. 16B).

(4) When the output signal of the pressure sensor 240 indicates that the gas pressure in the mixing portion 231 is the substantially normal pressure, the control portion 300 opens the opening/closing valve 235 and the opening/closing valve 232. Thus, air is introduced into the mixing portion 231 by the compressor 112, and the hydrogen-off gas and the air are mixed to form the diluted gas. The diluted gas flows into the confluence portion 205a of the air off-gas passage 205 through the air off-gas passage 205 (refer to FIG. 16C and FIG. 16E).

(5) After a predetermined time has elapsed since the opening/closing valve 235 and the opening/closing valve 232 are opened, or after the gas pressure detected by the pressure sensor 240 has decreased, the control portion 300 further opens the opening/closing valve 233 such that the flow quantity of the mixed gas flowing into the confluence portion 205a of the air off-gas passage 205 is maintained at a constant value.

(6) After the predetermined time has elapsed since the opening/closing valve 232 is opened, the control portion 300 closes the opening/closing valve 235, the opening/closing valve 232, and the opening/closing valve 233.

(7) The control portion 300 repeatedly performs the steps (1) to (6) during the aforementioned purge operation.

Since this control is performed, a difference between the pressure of the air off-gas and the pressure of the hydrogen off-gas at the confluence portion 205a can be adjusted, and the pulsed change in the quantity of the discharged hydrogen off-gas can be reduced. Further, since the hydrogen off-gas is introduced to the mixing portion 231 from the hydrogen off-gas circulation passage 204, and the diluted hydrogen off-gas is discharged from the mixing portion 231 to the air off-gas passage 205 during different time periods, the introduction of the hydrogen off-gas discharged from the fuel cell 121 into the mixing portion 231 and the discharge of the hydrogen-off gas from the mixing portion 231 to the air off-gas passage 205 can be performed without interfering with each other (under different conditions), which is advantageous.

In the aforementioned embodiment, the compressor 112 is used for generating the negative pressure in the mixing portion 231. However, an air pump or a vacuum pump may be provided in order to generate the negative pressure in the mixing portion 231. Also, when the dilution air is introduced into the mixing portion 231, the concentration of hydrogen in the hydrogen off-gas may be reduced by increasing the output of the compressor (for example, by increasing the rotational speed) so as to increase the quantity of the air supplied to the mixing portion 231. Also, each of the opening/closing valves 235 and 236 may be a valve whose opening amount can be adjusted. Also, since the opening/closing valve 235 and the opening/closing valve 236 are operated complementarily, one passage can be formed between the opening/closing valves 235 and 236, and the mixing portion 231 by connecting the negative pressure forming passage 208 to the dilution air supply passage 207. Also, the pressure adjustment can be performed with higher accuracy by using a valve whose opening amount can be adjusted as the opening/closing valve 235 and/or the opening/closing valve 236, and combining the valve with the compressor 112.

As described above, in the embodiment of the invention, the flow quantity control valve (adjusting valve) 133 for adjusting the flow quantity of the hydrogen off-gas is provided in the hydrogen off-gas passage (hydrogen exhaust passage) 203 for the fuel cell 121. The flow quantity control valve 133 suppresses the pulsed change in the flow quantity of the hydrogen off-gas that is intermittently discharged from the fuel cell such that the flow quantity becomes substantially constant, and supplies the hydrogen off-gas to the combustor or the muffler. The constant quantity is appropriately adjusted according to the discharge quantity of the hydrogen-off gas, the quantity of the hydrogen gas supplied to the fuel cell, the air-fuel ratio between the discharged hydrogen and the oxygen, the temperature of the catalyst in the combustor, the concentration of the hydrogen that remains in the gas discharged to the atmosphere from the combustor, and the like. Thus, the operation of the catalyst becomes stable, and the combustion treatment for the hydrogen gas can be performed using a small quantity of the catalyst. Also, it is possible to perform the combustion treatment for the hydrogen gas more perfectly, and to deal with the increase/decrease of the hydrogen-off gas. Also, it is possible to maintain the concentration of the remaining hydrogen in the gas discharged to the outside of the vehicle at a low value.

The aforementioned embodiments can be combined with each other in various manners. For example, although the quantities of the hydrogen off-gas and the air off-gas that are supplied to the combustor 134 are adjusted such that the air-fuel ratio becomes the optimum value in the seventh embodiment, the supply quantity of the hydrogen off-gas may be decreased, and the supply quantity of the air off-gas may be increased when the temperature of the catalyst in the combustor 134 becomes higher than a predetermined value in the seventh embodiment.

Also, in the ninth embodiment, the supply quantity of the hydrogen off-gas may be decreased, and the supply quantity of the air off-gas may be increased when the temperature of the catalyst in the combustor 134 becomes higher than a predetermined value. Further, the flow quantity control valves 133 and 135 may be controlled such that the hydrogen in the discharged gas is removed when the concentration of the hydrogen in the gas discharged from the combustor 134 becomes higher than a predetermined value.

Also, the aforementioned fuel cell system may be applied to a system or a device other than the vehicle, and the combustor 134 may be a burner.

In the first to the ninth embodiments, instead of supplying each of the hydrogen off-gas and the air off-gas directly to the combustor 134, the hydrogen off-gas and the air off-gas may be mixed in the chamber 231 as shown in FIG. 12, and then the mixed gas may be supplied to the combustor 134. In such a configuration, since the gas formed by sufficiently mixing the hydrogen off-gas and the air off-gas is supplied to the combustor 134, the hydrogen in the gas is efficiently oxidized by the catalyst.

In the aforementioned embodiments, a chamber for mixing the hydrogen off-gas and the air off-gas is provided between the flow quantity control valve 133 and the combustor 134. Also, when the concentration of the hydrogen in the hydrogen off-gas discharged from the fuel cell is low, the combustor 134 may be the combustor shown in FIG. 10A.

In the aforementioned embodiments, the hydrogen off-gas is intermittently discharged from the fuel cell. However, the invention can be applied also in the case where the hydrogen off gas is continuously discharged from the fuel cell. It is expected that the same effects can be obtained by suppressing the change in the quantity of the hydrogen gas that is continuously discharged from the fuel cell also in this case.

1. A fuel cell system which reduces a concentration of hydrogen in hydrogen off-gas discharged from a fuel cell, and then discharges the hydrogen off-gas to atmosphere; comprising:
an adjusting valve which adjusts a flow quantity of the hydrogen of f-gas to a constant flow quantity, the adjusting valve being provided in an exhaust passage through which the hydrogen off-gas discharged from the fuel cell is guided to an outside of the fuel cell system, and
a chamber which temporarily stores gas including the hydrogen off-gas, wherein the adjusting valve is provided downstream of the chamber in the exhaust passage.

2. The fuel cell system according to claim 1, wherein the adjusting valve is an electromagnetic valve whose opening/closing amount is controlled based on an operating state of the fuel cell system.

3. The fuel cell system according to claim 2, further comprising:
a gas state detecting device that detects a state quantity of the hydrogen off-gas in the exhaust passage as the operating state of the fuel cell system, wherein the adjusting valve is controlled based on the detected state quantity.

4. The fuel cell system according to claim 1, further comprising:
a confluence portion in which a fluid containing oxygen and the hydrogen off-gas are mixed, the confluence portion being provided downstream of the adjusting valve.

5. The fuel cell system according to claim 4, wherein the confluence portion includes a hydrogen reducing device that reduces the quantity of hydrogen in the hydrogen off-gas by mixing the hydrogen off-gas and the fluid.

6. The fuel cell system according to claim 5, wherein the hydrogen off-gas reducing device includes a conversion device that oxidizes the hydrogen off-gas using the fluid.

7. The fuel cell system according to claim 6, wherein the gas state detecting device includes a first detecting device that detects a state quantity of the hydrogen off-gas flowing into the conversion device, and the adjusting valve adjusts a supply quantity of the fluid supplied to the conversion device based on the detected state quantity of the hydrogen off-gas.

8. The fuel cell system according to claim 6, further comprising:
a second detecting device that detects a quantity state of the fluid flowing into the conversion device as the operating state of the fuel cell system, wherein the adjusting valve is an electromagnetic valve whose opening/closing amount is controlled based on the detected state quantity of the fluid.

9. The fuel cell system according to claim 6, wherein the conversion device includes a catalyst that oxidizes the hydrogen in the hydrogen off-gas; the fuel cell system further includes a temperature detecting device that detects a temperature of the catalyst as the operating state of the fuel cell system; and the opening/closing amount of the adjusting valve is controlled based on the detected temperature.

10. The fuel cell system according to claim 9, wherein a supply quantity of the hydrogen off-gas supplied to the conversion device is controlled based on the detected temperature using the adjusting valve.

11. The fuel cell system according to claim 9, wherein the supply quantity of the fluid supplied to the conversion device is controlled based on the detected temperature using the adjusting valve.

12. The fuel cell system according to claim 8, wherein the fluid is oxygen off-gas discharged from the fuel cell; the first detecting device detects at least one of a flow quantity of the hydrogen off-gas and a concentration of hydrogen in the hydrogen off-gas; the second detecting device detects at least one of a flow quantity of the oxygen off-gas and a concentration of oxygen in the oxygen off-gas; and the opening/closing amount of the adjusting valve is adjusted according to the detected at least one of the flow quantity of the hydrogen off-gas and the concentration of hydrogen in the hydrogen off-gas, and the detected at least one of the flow quantity of the oxygen off-gas and the concentration of oxygen in the oxygen off-gas.

13. The fuel cell system according to claim 6, further comprising:
a third detecting device that detects a concentration of hydrogen in exhaust gas discharged from the conversion device as the operating state of the fuel cell system, wherein the opening/closing amount of the adjusting valve is controlled based on the detected concentration of hydrogen.

14. The fuel cell system according to claim 5, wherein the hydrogen reducing device includes a diluting device that reduces a concentration of hydrogen in the hydrogen off-gas.

15. The fuel cell system according to claim 2, further comprising:
a fourth detecting device that detects an operating state of the fuel cell as the operating state of the fuel cell system, wherein the opening/closing amount of the adjusting valve is controlled based on the operating state of the fuel cell.

16. The fuel cell system according to claim 3, wherein the gas state detecting device is provided upstream of the adjusting valve, and the adjusting valve is controlled based on the detected state quantity.

17. The fuel cell system according to claim 16, wherein the gas state detecting device detects pressure of the hydrogen off-gas as the state quantity of the hydrogen off-gas, and the opening/closing amount of the adjusting valve is adjusted according to the detected pressure.

18. The fuel cell system according to claim 3, wherein the gas state detecting device obtains the quantity state of the hydrogen off-gas based on an opening/closing state of a hydrogen purge valve that discharges the hydrogen off-gas from the fuel cell to the exhaust passage.

19. The fuel cell system according to claim 1, wherein the flow quantity of the hydrogen off-gas that is guided to the exhaust passage is adjusted by adjusting an opening area of the adjusting valve.

20. The fuel cell system according to claim 19, wherein the exhaust passage includes at least two exhaust passages through which the hydrogen off-gas is guided to the outside of the fuel cell system; and the adjusting valve includes opening/closing valves each of which is provided in each of the at least two exhaust passages.

21. The fuel cell system according to claim 20, wherein opening/closing of each of the opening/closing valves is controlled according to the detected state quantity.

22. (canceled)

23. The fuel cell system according to claim 21, wherein the gas state detecting device detects pressure in the chamber; and the opening/closing amount of the adjusting valve is adjusted according to the detected pressure.

24. The fuel cell system according to claim 1, wherein the adjusting valve is a mechanical valve.

25. A fuel cell system which dilutes hydrogen off-gas discharged from a fuel cell, and then discharges the hydrogen off-gas to atmosphere, comprising:
a first passage through which dilution gas that can be used for diluting the hydrogen off-gas flows;
a second passage through which the hydrogen off-gas from the fuel cell is discharged;
a confluence portion to which the first passage and the second passage are connected; and
a pressure adjusting device that adjusts pressure of the hydrogen off-gas and pressure of the dilution gas in the confluence portion, the pressure adjusting device being provided in at least one of the first passage and the second passage.

26. The fuel cell system according to claim 25, wherein the pressure adjusting device is provided in the second passage.

27. The fuel cell system according to claim 25, wherein the pressure adjusting device includes an air compressor provided in an oxidizing gas supply passage on a cathode side of the fuel cell, and an adjusting passage that connects at least one of an intake side and a discharge side of the air compressor and the second passage.

28. The fuel cell system according to claim 27, wherein the pressure adjusting device includes an opening/closing valve whose opening/closing amount can be adjusted according to pressure in the confluence portion, the opening/closing valve being provided in the adjusting passage.

29. The fuel cell system according to claim 27, wherein the adjusting passage includes a first adjusting passage that connects a supply passage on the intake side of the air compressor and the second passage, and a second adjusting passage that connects a supply passage on the discharge side of the air compressor and the second passage; the fuel cell system further includes a pressure control device that makes the pressure of the hydrogen off-gas lower than the pressure of the dilution gas in the confluence portion by forming negative pressure in the second passage through the first adjusting passage using the air compressor, and making the pressure of the hydrogen off-gas in the second passage higher than the pressure of the dilution gas in the confluence portion through the second adjusting passage using the air compressor.

30. A fuel cell system which dilutes hydrogen off-gas discharged from a fuel cell, and then discharges the hydrogen off-gas to atmosphere, comprising:
a first passage through which dilution gas that can be used for diluting the hydrogen off-gas flows;
a second passage through which the hydrogen off-gas from the fuel cell is discharged;
a confluence portion to which the first passage and the second passage are connected; and
a pressure adjusting device which adjusts pressure of the hydrogen off-gas and pressure of the dilution gas in the confluence portion, the pressure adjusting device being provided in at least one of the first passage and the second passage.

31. The fuel cell system according to claim 9, wherein the fluid is oxygen off-gas discharged from the fuel cell; the first detecting device detects at least one of a flow quantity of the hydrogen off-gas and a concentration of hydrogen in the hydrogen off-gas; the second detecting device detects at least one of a flow quantity of the oxygen off-gas and a concentration of oxygen in the oxygen off-gas; and the opening/closing amount of the adjusting valve is adjusted according to the detected at least one of the flow quantity of the hydrogen off-gas and the concentration of hydrogen in the hydrogen off-gas, and the detected at least one of the flow quantity of the oxygen off-gas and the concentration of oxygen in the oxygen off-gas.

32. The fuel cell system according to claim 4, further comprising:
a fourth detecting device that detects an operating state of the fuel cell as the operating state of the fuel cell system, wherein the opening/closing amount of the adjusting valve is controlled based on the operating state of the fuel cell.

33. The fuel cell system according to claim 4, wherein the gas state detecting device is provided upstream of the adjusting valve, and the adjusting valve is controlled based on the detected state quantity.
